(19) United States
(12) Patent Application Publication
(10) Pub. No.: US 2026/0147573 A1
(43) Pub. Date: May 28, 2026

(54) MULTI-TAKEN PREDICTION ENTRIES FOR PREDICTION RESUMPTION

(71) Applicant: Arm Limited, Cambridge (GB)

(72) Inventors: Houdhaifa BOUZGUARROU, Valbonne (FR); Rami Mohammad AL SHEIKH, Morrisville, NC (US); Michael Brian SCHINZLER, Round Rock, TX (US); Guillaume BOLBENES, Vallauris (FR); Sergio SCHULER, Austin, TX (US)

(21) Appl. No.: 18/961,938

(22) Filed: Nov. 27, 2024

(51) Int. Cl. G06F 9/38; G06F 9/355

(52) U.S. Cl. CPC G06F 9/3806; G06F 9/3557

(57) ABSTRACT

An apparatus comprising prediction storage circuitry to store a plurality of prediction entries, each prediction entry indicative of whether a respective branch instruction is predicted to be taken or not taken. At least one prediction entry supports an encoding of a multi-taken entry indicating that the respective branch instruction and at least one subsequent branch instruction are each predicted to be taken. The apparatus also comprises prediction resumption circuitry to identify, based on stored information dependent on the multi-taken entry, a prediction resumption address in response to a flush signal, where the prediction resumption address is an address in respect of which at least one prediction is to be generated after the flush signal.

### BACKGROUND

### Technical Field

The present technique relates to the field of data processing. In particular, the present techniques relates to branch prediction.

### Technical Background

Data processing devices may comprise branch predictors for predicting whether a branch instruction is to be taken or not taken. Such predictions may be used for controlling the fetching of instructions from a memory system. When a prediction is incorrect, the processing pipeline is flushed of instructions that have been fetched based on that incorrect prediction. Instructions may then begin to be fetched based on the known outcome of a branch instruction until the branch predictor has restarted generating new predictions.

### SUMMARY

At least some examples of the present technique provide an apparatus comprising: prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and prediction resumption circuitry configured to identify, based on stored information dependent on the multi-taken entry, a prediction resumption address in response to a flush signal, the prediction resumption address being an address in respect of which at least one prediction is to be generated after the flush signal.

At least some examples of the present technique provide a system comprising: the apparatus described above, implemented in at least one packaged chip; at least one system component; and a board, wherein the at least one packaged chip and the at least one system component area assembled on the board.

At least some examples of the present technique provide a chip-containing product comprising the system described above, wherein the system is assembled on a further board with at least one other product component.

At least some examples of the present technique provide a method comprising: storing a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and identifying, based on stored information dependent on the multi-taken entry, a prediction resumption address in response to a flush signal, the prediction resumption address being an address in respect of which at least one prediction is to be generated after the flush signal.

At least some examples of the present technique provide a non-transitory computer-readable medium storing computer-readable code for fabrication of an apparatus comprising: prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and prediction resumption circuitry configured to identify, based on stored information dependent on the multi-taken entry, a prediction resumption address in response to a flush signal, the prediction resumption address being an address in respect of which at least one prediction is to be generated after the flush signal.

Further aspects, features and advantages of the present technique will be apparent from the following description of examples, which is to be read in conjunction with the accompanying drawings.

### BRIEF DESCRIPTION OF THE DRAWINGS

FIG. 1 illustrates a data processing apparatus comprising an alternate prediction cache;

FIG. 2 illustrates a prediction resumption address being identified based on an alternate path prediction;

FIG. 3 illustrates a sequence of steps for generating predictions;

FIG. 4 illustrates an example configuration of a tagged-geometric length predictor comprising a plurality of storage structures;

FIG. 5 illustrates an example of a set-associative storage structure storing prediction entries;

FIG. 6 illustrates a sequence of steps for generating a main path prediction and an alternate path prediction using the tagged-geometric length predictor;

FIGS. 7A and 7B illustrate a graph of program flow information comprising observed paths from a candidate branch instruction;

FIGS. 8A and 8B illustrate a graph of program flow information comprising observed paths from a candidate polymorphic branch instruction;

FIG. 9 illustrates a sequence of steps for updating the program flow information;

FIG. 10 illustrates a sequence of steps for generating a main path prediction and an alternate path prediction using the program flow information;

FIGS. 11A to 11J illustrate specific examples of main and alternate paths of program flow that may be predicted;

FIG. 12 illustrates a prediction pipeline comprising an alternate prediction cache;

FIG. 13 illustrates a system and a chip-containing product;

FIG. 14 illustrates determination of a prediction resumption address based on a multi-taken entry; and

FIGS. 15A and 15B illustrate multi-taken entries.

### DESCRIPTION OF EXAMPLES

In accordance with some example embodiments, there is provided an apparatus comprising branch prediction circuitry configured to generate a main path prediction in respect of a given branch instruction of a given block of one or more instructions. If the prediction is incorrect, for example as determined by a branch resolution unit that executes the given branch instruction, then the branch prediction circuitry may be required to begin generating predictions in respect of a different block of instructions. For this purpose, the apparatus comprises block skipping circuitry responsive to a flush signal indicative of the main path prediction being incorrect to control the branch prediction circuitry to begin generating predictions in respect of a subsequent block of instructions identified by a prediction resumption address. This approach allows the branch prediction circuitry to skip ahead of the instructions that start being fetched immediately following the flush.

According to the present techniques, the branch prediction circuitry is configured to further generate at least one alternate path prediction in respect of an alternate path of program flow predicted to be followed if the main path prediction is incorrect. The apparatus is further provided with an alternate prediction cache for storing the alternate path predictions, at least until the main path prediction is determined to be incorrect. The block skipping circuitry is configured to identify the prediction resumption address based on the at least one alternate path prediction, and to support an encoding of the alternate path prediction that indicates that the alternate path of program flow includes at least one taken branch. Accordingly, based on the alternate path prediction, the prediction resumption address can be set further into the future such that the branch prediction circuitry is controlled to begin generating predictions further into the future more quickly. This approach therefore allows the fetching of new instructions to proceed following a path that could include a taken branch without needing to wait for the branch prediction circuitry to generate a prediction. Hence, the fetching of instructions is at less risk of halting while the branch prediction circuitry resumes generating predictions following a flush.

In some examples, a prediction pipeline may be present, in which multiple stages of the prediction process may take place. The branch prediction circuitry returns the main path prediction and the at least one alternate path prediction at a prediction stage of a prediction pipeline. The alternate prediction cache returns the at least one alternate path prediction at a control stage, which is earlier in the prediction pipeline than the prediction stage. When using the prediction pipeline arrangement, the main path prediction being incorrect may cause prediction pipeline bubbles to occur due to in-progress predictions being flushed from the prediction pipeline, while new predictions begun after prediction is resumed require one or more cycles to reach the prediction stage. The pipeline bubbles then reduce the performance of fetching instructions. In accordance with the present techniques, using the alternate prediction cache to return the alternate path prediction to an earlier point of the prediction pipeline, the control stage can restart fetching more quickly after a flush, i.e. faster by at least one cycle. This reduces the size of the pipeline bubbles. It will be appreciated that the prediction pipeline is not particularly limited, and does not necessitate that the branch prediction circuitry is confined to that prediction pipeline and in some examples, the branch prediction circuitry may span several prediction pipeline stages preceding the prediction stage, such that the main path prediction and alternate path prediction are returned at that prediction stage.

In some examples, the branch prediction circuitry is configured to generate the main path prediction and at least one alternate path prediction from a single lookup in prediction data. In this way, the alternate path prediction may be generated without incurring any additional latency for generation of the main path prediction. This may be achieved in various different ways depending on the particular prediction mechanism used in the branch prediction circuitry.

In some examples, the branch prediction circuitry comprises history tracking circuitry to maintain a program flow history based on predicted branch instructions satisfying a program flow history update condition, and at least one set-associative storage structure configured to store prediction data, in which the at least one set-associative storage structure comprises sets indexed by a portion of the program flow history that is independent of information relating to a most recently predicted branch instruction satisfying the program flow history update condition. In such examples, looking up the storage structure based on a given index may result in a hit on multiple entries of the prediction data. Accordingly, when looking up prediction data in respect of the main path prediction, other entries from the prediction data are also identified in the same lookup. These other entries may then be used for one or more alternate path predictions. By excluding the most recent predicted branch that satisfied the program flow history update condition from the information used to generate the set index, the entries in the same set are more likely to provide alternate predictions that may be of use if a recent branch was mispredicted. This is because, since the set is indexed independently of information relating to a most recently predicted branch instruction, the prediction entries in that set may indicate a prediction for different paths of program flow which may involve different branches as the most recent branch satisfying the program flow history update condition (but which share a common program flow path up to the respective most recently taken branch in those paths). This approach therefore provides a way of obtaining multiple prediction entries relating to alternative paths of program flow in a single lookup of the set-associative storage structure.

The program flow history update condition may be any condition evaluated to determine whether the program flow history should be updated based on a given predicted branch. In some examples, the program flow history update condition may be satisfied for both predicted taken and predicted not-taken branch instructions. However, it will be appreciated that the amount of stored data used to represent the program flow history (and hence frequency of updates) may be reduced by limiting the program flow history update condition to being satisfied for predicted taken branch instructions but not being satisfied for predicted not-taken branch instructions. In some examples, other criteria may also be considered to determine whether the program flow history should be updated based on a given predicted branch (e.g. in implementations using local history buffers, another criterion may be whether the program counter address and/or branch target address of a given branch meets a certain condition, such as being within a particular address range). Hence, the particular program flow history update condition to be satisfied in order for a given predicted branch to cause an update to the program flow history may vary from one embodiment to another, but in general by indexing the set-associative storage structure using an index value which is independent of the most recent branch that caused the program flow history to be updated, this means a number of entries can be maintained in the same set that relate to alternate paths of program flow that are possible paths that could follow a given earlier mispredicted branch.

When multiple prediction entries are retrieved in a lookup of the set-associative storage structure, some examples may distinguish those prediction entries by storing, in each set, two or more prediction entries in association with a respective tag value to be compared with a tag. The tag is dependent on a portion of the program flow history that is dependent on the information relating to the most recently predicted branch instruction satisfying the program flow history update condition. The tag can be compared with tag values stored in each prediction entry within an indexed set, to distinguish which prediction entry should be used to generate the main path prediction. Any one or more other prediction entries within the hit set may then be used to generate the at least one alternate path prediction.

In some examples, the indication of the given block, i.e. on which the tag as dependent, may be dependent on a program counter value. The program counter value may be that of the given branch instruction or another instruction from the given block of instructions, e.g. the first instruction in the block. The program counter value may also be hashed as part of generating the tag.

It will be appreciated that, in some examples, the index may be further independent of information relating to a second most recently predicted branch instruction satisfying the program flow history update condition. This may allow the set-associative storage structure to hit on more entries but at the cost of prediction accuracy. In examples that are configured for particularly aggressive prediction, increasing the independence of the index from recently taken branch instructions can allow the alternate path predictions to be generated even further into the future. For example, further alternate path predictions may be generated in respect of further branch instructions expected to be encountered beyond what is currently predicted for the alternate path, thereby extending the alternate path prediction.

The set-associative storage structure described above may be one of a plurality of set-associative storage structures. One example of such a prediction mechanism is a tagged-geometric length (TAGE) predictor. In some examples, there is a long-history storage structure associated with a long history length and a short-history storage structure associated with a short history length. The branch prediction circuitry may then identify the prediction entries in those storage structures for generating the predictions, based on different lengths of the current history. It will be appreciated that additional storage structures may also be present, such as one or more medium-history storage structures, each associated with different history lengths between the long history length and the short history length.

Some examples of the above arrangement may prioritise a hit in the long-history storage structure over a hit in a short-history storage structure for identifying a prediction entry to be used for the main prediction. Matching a prediction entry against a longer history of program flow is indicative that a prediction generated in dependence on that prediction entry is more likely to be accurate.

While the present techniques are useful for improving the resumption of fetching instructions, in some examples, it may be beneficial to control the allocation of alternate path predictions to the alternate prediction cache depending on past observation of observed paths which are more likely to provide good alternative predictions to the main path prediction. Accordingly, in some examples, the apparatus may comprise flow tracking circuitry configured to maintain program flow information indicative of one or more observed paths after a candidate branch instruction. In a case where the given branch instruction corresponds to the candidate branch instruction, the branch prediction circuitry is configured to store the at least one alternate path prediction in the alternate prediction cache in response to the alternate path of program flow corresponding to one of the one or more observed paths. Hence, if an alternate path prediction is generated associated with a candidate branch instruction, but does not correspond to any of the observed paths tracked for the candidate branch instruction in the flow tracking circuitry, the branch prediction circuitry may discard the alternate path prediction instead of storing it to the alternate prediction cache. This approach therefore improves the utilisation of the available capacity of the alternate prediction cache by limiting the predictions that may be stored to paths of program flow that have been observed before. Accordingly, with better utilisation of the alternate prediction cache, the alternate prediction cache may be implemented with a smaller capacity which reduces the associated hardware cost. Viewed another way, for a given capacity of the alternate prediction cache the available capacity can be better used to provide alternate path predictions more likely to be of use following a flush, improving performance for a given budget of circuit area/power.

In some examples, the one or more observed paths comprise information identifying at least one subsequent branch instruction encountered after the candidate branch instruction. Accordingly, the observed paths may be more than just whether the candidate branch instruction is predicted to be taken or not taken. Indeed, the observed paths may include whether the subsequent branch instruction was observed to be taken or not taken, and may include whether another subsequent branch instruction was observed to be taken or not taken. Hence, for an alternate path prediction to be stored in the alternate prediction cache, an alternate path prediction may be required to correspond with such an observed path.

Given a finite capacity for encoding details about observed paths of program flow in the flow tracking circuitry, in some examples, the flow tracking circuitry is configured to enforce a maximum limit for a number of subsequent conditional branch instructions in each of the one or more observed paths. This therefore limits the extent to which an observed path consisting of conditional branches is relevant for a particular candidate branch instruction. Nonetheless, unconditional branches that are observed as part of the observed paths may still be considered relevant and can be encoded more efficiently than a conditional branch as there may be less need to encode information about confidence in whether the branch is taken. Hence, the flow tracking circuitry may further support at least one observed path comprising a number of conditional branches corresponding to the maximum limit followed by at least one unconditional branch instruction. Hence, the observed path may extend past the maximum limit if the extension is made up of unconditional branches. This can help improve performance by enabling the alternate path prediction to cause the resumption of prediction lookups on a flush to be even further into the future.

The flow tracking circuitry may be used for enabling the alternate path prediction for a subset of branch instructions. In particular, since the present techniques can help to improving performance in the event of an incorrect main path prediction, the flow tracking circuitry may be used for branch instructions that are considered to be difficult to predict. For example, the flow tracking circuitry may select the candidate branch instruction in response to a determination that the candidate branch instruction has a misprediction rate exceeding a threshold value. This can help to prioritise finite capacity in the flow tracking circuitry for those hardest to predict branches, which are most likely to benefit from use of the alternate prediction cache to speed up recovery from a flush caused by a misprediction. Hence, this approach can improve the amount of performance uplift obtained for a given circuit area and power budget.

In an apparatus that comprises a branch target buffer, one or more values indicative of the misprediction rate for one or more branch instructions may be available for use when the flow tracking circuitry selects a candidate branch instruction. The flow tracking circuitry may select which branches are selected as the candidate branch instruction(s) depending on the one or more values indicative of the misprediction rate tracked by the branch target buffer.

In some examples, several alternate path predictions may be stored in the alternate prediction cache simultaneously. Therefore, it is useful to be able to differentiate between different alternate path prediction to identify which one should be used by the block skipping circuitry when identifying a prediction resumption address in response to a flush signal. Accordingly, the alternate prediction cache may store the alternate path predictions in association with one or more pieces of information. Different pieces of information may be combined to form a tag for each entry of the alternate prediction cache.

In some examples, the alternate prediction cache may be configured to store the at least one alternate prediction in association with an identifier of the given block of instructions. The identifier may be, for example, dependent on a program counter value associated with the given branch instruction or the first instruction of the block. The identifier may also be, for example, an incrementing value corresponding to the position of the block of instructions in the program. Such an identifier allows the alternate prediction cache to differentiate between alternate path predictions in respect of different blocks of instructions.

In some examples, the alternate prediction cache may be configured to store the at least one alternate path prediction in association with an offset of the given branch instruction. The offset may be relative to the beginning or end of the block of instructions or relative to another base address stored elsewhere. Such an offset allows the block skipping circuitry to determine which instructions should be fetched on the alternate path represented by the alternate path prediction.

In some examples, the given branch instruction is a polymorphic branch instruction. A polymorphic branch instruction is a branch that has a plurality of possible target instructions when the branch is taken (e.g. where the branch target address depends on a data-dependent value generated by earlier instructions). Hence, the main path prediction may comprise a first target address, and the at least one alternate path prediction may comprise a second target address. The alternate prediction cache may then be configured to store the at least one alternate prediction in association with the second target address. Accordingly, the alternate prediction cache may differentiate between alternate path predictions in respect of the same polymorphic branch instruction, and so enable faster recovery from a misprediction based on selecting the wrong target address for a polymorphic branch instruction.

In some examples, the branch prediction circuitry may predict that the alternate path prediction comprises a return instruction. A return instruction may be used to signal the end of a called function, hence causing the program flow to return to a previous sequence of instructions. When such functions are called, a return address may be added to a data structure in memory known as a call-return stack. The call-return stack may be arranged as a LIFO (last in, first out) structure and maintains the target addresses of the return instruction corresponding to the called function. Accordingly, if such a return instruction is predicted as part of the alternate path prediction, the branch prediction circuitry may generate that alternate path prediction to comprise a pointer to the call-return stack, which may be stored in the alternate prediction cache so that the return address can be identified when recovering from a flush.

In accordance with some examples, there is provided an apparatus comprising prediction storage circuitry configured to store a plurality of prediction entries, where each prediction entry is indicative of whether a respective branch instruction is predicted to be taken or not taken. At least one of the prediction entries supports an encoding of a multi-taken entry, which indicates that the respective branch instruction and at least one subsequent branch instruction are each predicted to be taken. In this way, a multi-taken entry in the prediction storage circuitry may be used to generate a prediction of multiple branch instructions using one entry, thereby allowing improved utilisation of the prediction storage circuitry.

The apparatus further comprises prediction resumption circuitry configured to identify, based on stored information dependent on the multi-taken entry, a prediction resumption address in response to a flush signal, the prediction resumption address being an address in respect of which at least one prediction is to be generated after the flush signal. The prediction resumption circuitry may operate in a similar way to the block skipping circuitry described previously (and hence the prediction resumption circuitry may in some examples have any of the features described earlier for the block skipping circuitry).

Hence, after a flush, the multi-taken entry can be used to identify a target address at least one branch further into the future than would be possible in an implementation not supporting multi-taken entries. By resuming prediction at this address, a fetch unit may fetch instructions following a path of at least two taken branches until that target address without needing to wait for new predictions. Accordingly, the fetching of instructions is at less risk of halting while waiting for new predictions to be generated after the flush signal.

In some examples, prediction circuitry performs a lookup in the prediction storage circuitry to generate a prediction in respect of a given branch instruction, and the prediction circuitry generates and stores the stored information in a prediction resumption cache in response to generating prediction in respect of a given branch instruction. In some such examples, the stored information may be indicative of an alternate path prediction and the prediction resumption cache may correspond to the alternate prediction cache mentioned earlier. Hence, the stored information can be retrieved from the prediction resumption cache in the event of a flush. As in the examples described earlier, information from the prediction resumption cache can be returned at an earlier pipeline stage than information from the prediction storage circuitry.

In some examples, the flush signal is indicative of the prediction being incorrect. When this occurs, a processing pipeline is flushed and the prediction circuitry stops generating predictions along the path that is now known to be incorrect. The prediction circuitry is instead controlled to resume the generation of predictions under the control of the prediction resumption circuitry as described above.

In some examples, the branch prediction circuitry is configured to generate the prediction and the stored information from a single lookup in prediction storage circuitry. In this way, the stored information, e.g. identifying an alternate path prediction, may be generated without incurring any additional latency for generation of the prediction. This may be achieved in various different ways depending on the particular prediction mechanism used in the branch prediction circuitry.

For example, the multi-taken entry may be located using the set-associative storage structure indexed by a portion of the program flow history that is independent of information relating to a most recently predicted branch instruction satisfying the program flow history update condition, as in the examples described above. The multi-taken entry may be used in place of any of the prediction entries described in the previous examples to enable the alternate path prediction to be extended without requiring an additional lookup.

In some examples, the two or more prediction entries in each set of the set-associative storage structure support the encoding of the multi-taken entry. In this way, a multi-taken entry may be identified as part of any lookup performed in the prediction storage circuitry. In other examples, only a subset of sets, or only a subset of entries (ways) within a set could support the multi-taken entry encoding, with other sets or entries being restricted to encoding non-multi-taken entries which represent a single taken branch.

In some examples, flow tracking circuitry, such as the flow tracking circuitry described above for the earlier examples, may, in a case where a prediction is to be generated in respect of a candidate branch instruction, control whether stored information, such as an alternate path prediction, is to be stored based on whether a multi-taken entry indicates a program flow corresponding to one of the one or more observed paths tracked by the flow tracking circuitry for the candidate branch instruction. Other aspects of the flow tracking circuitry described above may further be included in combination with the support for multi-taken entries. For example, the one or more observed paths may comprise information identifying at least one subsequent branch instruction encountered after the candidate branch instruction. In some examples, the flow tracking circuitry may enforce a maximum limit for a number of subsequent conditional branch instructions in each of the one or more observed paths, and the flow tracking circuitry may support at least one observed path comprising a number of conditional branch instructions corresponding to the maximum limit followed by at least one unconditional branch instruction. In some examples, the flow tracking circuitry may select the candidate branch instruction in response to a determination that the candidate branch instruction has a misprediction rate exceeding a threshold.

The prediction storage circuitry may be caused to store a multi-taken entry in response to particular observations in the program flow. In some examples, a subsequent branch instruction indicated as taken by the multi-taken entry may be an unconditional branch instruction and hence, that subsequent branch instruction is always taken. In other examples, the subsequent branch instruction indicated as taken by the multi-taken entry may be a conditional branch instruction which is predicted to be taken, and has an associated confidence value exceeds a threshold. Such a confidence value may have been developed over time as repeated correct predictions are made in respect of the subsequent branch instruction. In each of these examples, there is provided an opportunity to compress additional prediction information in a multi-taken prediction entry. Hence, when a lookup is performed in respect of generating a prediction for a respective branch instruction, the prediction storage circuitry can further provide a prediction for the program flow in providing predictions both for the respective branch instruction and the at least one subsequent branch instruction without incurring the additional latency associated with a further lookup.

The prediction resumption circuitry may in some examples correspond to the block skipping circuitry mentioned earlier, so the prediction resumption circuitry may in some examples have any of the features described for the block skipping circuitry.

Specific examples are now explained with reference to the drawings.

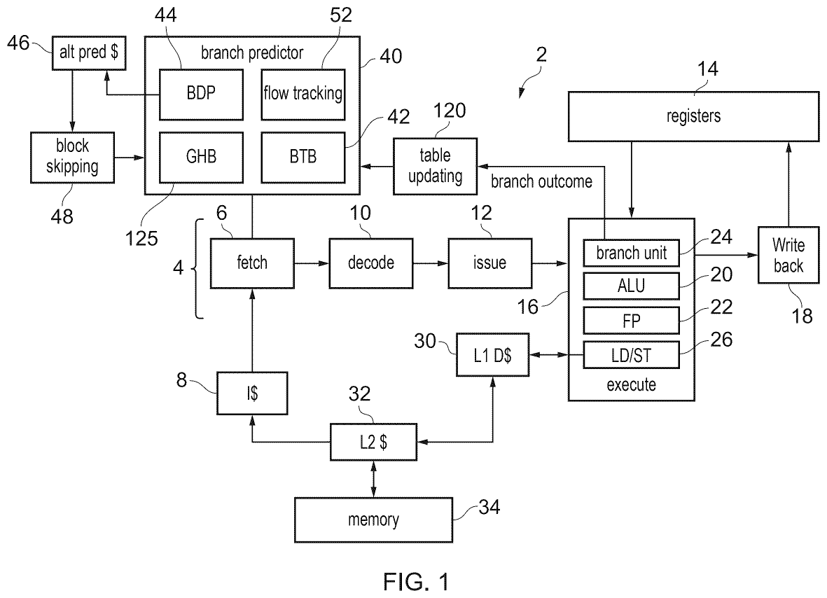

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage 16. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 1, the apparatus 2 includes a branch predictor 40 (corresponding to one example of the prediction circuitry in the appended claims) for predicting outcomes of branch instructions. The branch predictor 40 is looked up based on addresses of instructions provided by the fetch stage 6 and provides a prediction on whether those instructions are predicted to include branch instructions, and for any predicted branch instructions, a prediction of their branch properties such as a branch type, branch target address and a branch direction (predicted branch outcome, indicating whether the branch is predicted to be taken or not taken). The branch predictor 40 includes a branch target buffer (BTB) 42 for predicting properties of the branches other than branch direction, and a branch direction predictor (BDP) 44 for predicting the not taken/taken outcome (branch direction). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios. The branch predictor also has a global history buffer (a specific example of history tracking circuitry) 125, which maintains a program flow history based on predicted branch instructions satisfying the program flow history update condition. The program flow history represents a history of program flow preceding a current point of program flow for which a branch prediction is to be made. For example, each time a predicted branch instruction is predicted to occur by the branch predictor 40 that satisfies a program flow history update condition, information about that branch (e.g. information derived from the program counter address and/or branch target address and/or taken/not-taken outcome of the branch) can be logically inserted into the history tracking circuitry. The history tracking circuitry may function logically as a first-in-first-out buffer (in some implementations implemented as a circular buffer based on pointers tracking the point of the buffer at which the next entry should be inserted), so that the oldest entry may be overwritten by new information if there is no remaining invalid entry in the buffer. Hence, the history tracking circuitry tracks information about a certain number of recently predicted branches.

The program flow history update condition used to determine whether a given predicted branch instruction should cause an update of the program flow history may vary depending on implementation choice. In some examples, all predicted branches may cause an update of the program flow history. In other examples, the program flow history update condition may be satisfied when a predicted branch is predicted taken but not when the predicted branch is predicted not-taken.

In some examples, the program flow history update condition could also depend on other properties of the branch other than taken/not-taken outcome. For example, the program counter address and/or branch target address of the branch may be used to determine whether the program flow history update condition is satisfied. For example, the history tracking circuitry could comprise a number of local history buffers each updated based on branches with instruction addresses within a respective address range corresponding to that buffer, and in that case the instruction address (program counter address) of the branch may be checked to determine whether the program flow history update condition is satisfied.

Regardless of the particular program flow history update condition used for a given example of the history tracking circuitry 125, the program flow history tracked by the history tracking circuitry 125 can be used to form information used to lookup some prediction structures, such as the branch direction predictor 44. For example, the program flow history can be used to generate index information and/or tags for looking up a set-associative prediction storage structure, as discussed in more detail below.

As shown in FIG. 1, the apparatus 2 may have table updating circuitry 120 which receives signals from the branch unit 24 indicating the actual branch outcome of instructions, such as indications of whether a taken branch was detected in a given block of instructions, and if so the detected branch type, target address or other properties. If a branch was detected to be not taken then this is also provided to the table updating circuitry 120. The table updating circuitry 120 then updates state within the BTB 42, the branch direction predictor 44 and other branch prediction structures to take account of the actual results seen for an executed block of instructions, so that it is more likely that on encountering the same block of instructions again then a correct prediction can be made.

The predictions from the branch predictor 40, and in particular the branch direction from the BDP 44, may include several predictions in respect of a single looked up address. The predictions include a main path prediction which is used for controlling which instructions are fetched by the fetch stage 6, and an alternate path prediction which is stored to an alternate prediction cache 46. The alternate path predictions are indicative of an alternate path of program flow predicted to be followed if the main path prediction is incorrect. For example, if a branch instruction is predicted to be taken (i.e. as the main path prediction), then the alternate path prediction may be that the branch instruction is not taken and a subsequent branch instruction is taken instead.

As shown in FIG. 1, the apparatus 2 further comprises block skipping circuitry 48, which is configured to control how the branch predictor 40 restarts generating predictions in the event of a flush. A flush may occur in response to the branch unit 24 evaluating the outcome of the branch instruction differently to what was predicted in the main path prediction. Any instructions in the pipeline 4 that have been fetched by the fetch stage 6 based on the main path prediction are flushed, and the branch predictor 40 is caused to restart new predictions from a prediction resumption address. The block skipping circuitry 48 identifies the prediction resumption address based on an alternate path prediction stored in the alternate prediction cache 46.

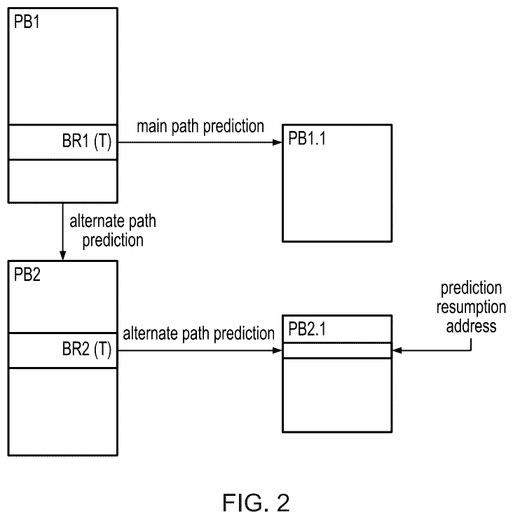

As mentioned above, the alternate path prediction may indicate that the alternate path of program flow includes at least one taken branch (which may be a different branch predicted by the main path prediction). Hence, the block skipping circuitry 48 may identify that the prediction resumption address is in a subsequent block of instructions following that taken branch. FIG. 2 illustrates one example of where the prediction resumption address could be. The program flow begins in processing block (PB) 1, which contains a sequence of instructions including a branch instruction BR1. When BR1 is detected by the branch predictor 40, the BDP 44 indicates a main path prediction of taken (T). The BTB 42 indicates PB1.1 as the block of instructions targeted by BR1. Accordingly, the branch predictor 40 may control the fetch stage 6 to commence fetching the instructions in PB1.1. The branch predictor 40 further generates the alternate path prediction indicating that BR1 is not taken and that subsequently the alternate program flow instead traverses to PB2, which contains the branch instruction BR2 which is predicted taken and branching to target block PB2.1.

When a flush signal is received, e.g. from the branch unit 24, the block skipping circuitry 48 identifies a prediction resumption address corresponding to the branch target in PB2.1 based on the alternate path prediction. The block skipping circuitry 48 then controls the branch predictor 40 to begin generating predictions in respect of the address within PB2.1 that corresponds to the branch target of BR2. Also, the fetch stage 6 may commence fetching the instructions that follow BR1, based on the alternate path that would be predicted to be taken if BR1 is not taken. The fetch stage 6 continues to fetch instructions following the alternate path of program flow up until the prediction resumption address without a new prediction being required from the branch predictor 40. Accordingly, the branch predictor 40 is capable of restarting predictions sufficiently further ahead than the instructions that are actually being fetched by the fetch stage 6, thereby reducing the likelihood that the fetch stage 6 is caused to halt fetching due to predictions not being available in time. Hence, performance of the fetch stage 6 immediately following the flush may be improved.

It will be appreciated that, while FIG. 2 illustrates one example of main and alternate program flow, the predictions may be different. Some examples may involve the alternate program flow including a plurality of taken branches through a plurality of processing blocks. Various examples of alternate program flows will be described later.

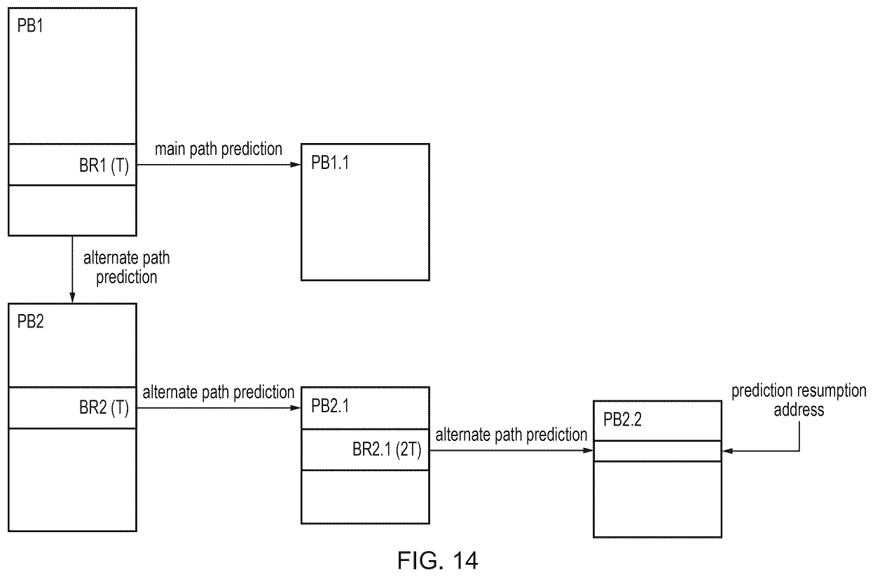

FIG. 14 illustrates another example of the main and alternate program flow in a case where a multi-taken entry is used for generating the alternate flow prediction. Similar to the example of FIG. 2, the main path prediction generated by the BDP 44 indicates that BR1 is taken (T). The branch predictor 40 further generates the alternate path prediction indicating that BR1 is not taken, and that subsequently the alternate program flow traverses to PB2, which contains the branch instruction BR2. In this example, the BDP 44 contains a multi-taken entry corresponding to BR2 which indicates that BR2 and a subsequent branch (i.e. BR2.1) are both predicted to be taken. Hence, the alternate path prediction is generated to indicate that BR2 is taken to branch to target block PB2.1, and also that BR2.1 is taken to branch to target block PB2.2. By compressing the prediction of multiple branch instructions into one entry, the alternate path prediction may be extended so as to identify a prediction resumption address even further into the future without requiring a separate prediction in respect of BR2.1.

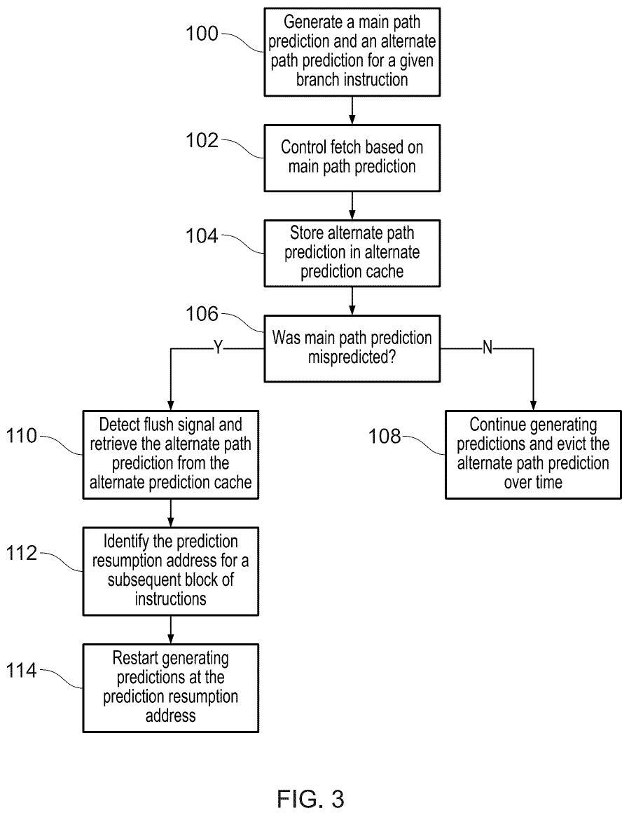

Accordingly, when a flush signal is received in this example, the block skipping circuitry 48 identifies a prediction resumption address corresponding to the branch target in PB2.2 based on the alternate path prediction. As above, the block skipping circuitry 48 then controls the branch predictor 40 to begin generating predictions in respect of the address within PB2.2 that corresponds to the branch target of BR2.1 while the fetch stage 6 commences fetching the instructions that follow BR1, and following the alternate path prediction via branches BR2 and BR2.1. The example of FIG. 3 therefore further improves performance of the fetch stage 6 by further reducing the likelihood that the fetch stage 6 is caused to halt fetching due to predictions not being available.

Multi-taken entries may be permitted in the BDP 44 in dependence on particular criteria. For example, if BR2.1 has been previously observed as an unconditional branch instruction or a conditional branch instruction that is predicted to be taken and associated with high confidence (e.g. exceeding a particular threshold), then the prediction entries for BR2 and BR2.1 may be permitted to be compressed into a single multi-taken entry.

It will be appreciated that a multi-taken entry is not limited to indicating that two branch instructions are to be taken. In some examples, a multi-taken entry may indicate that three or more branch instructions are each predicted to be taken.

FIG. 3 illustrates a sequence of steps for generating main and alternate path predictions, and skipping blocks. The process begins at step 100, where the branch predictor 40 identifies (e.g. based on a lookup of the BTB 42), a block of instructions comprising a given branch instruction, and generates a main path prediction and an alternate path prediction for the given branch instruction using the branch direction predictor 44. At step 102, the fetch stage 6 is controlled based on the main path prediction and at step 104, the alternate path prediction is stored in the alternate prediction cache 46. At step 106, it is determined whether the main path prediction was mispredicted. This may be determined by receiving a flush signal from the branch unit 24. It will be appreciated that for some execution pipelines, steps 100 to 104 may be repeated in respect of different branch instructions before the determination of step 106 can be performed. Hence, it will be understood that the process of FIG. 3 is only in respect of one branch instruction.

If the main path prediction is determined to be correct, then at step 108, the branch predictor 40 continues generating predictions as normal. The alternate path prediction may be eventually evicted from the alternate path prediction, for example according to an eviction policy that is enforced when allocating new alternate path predictions to the alternate prediction cache 46.

If the main path prediction is determined to be incorrect, then at step 110, a flush signal is detected and the block skipping circuitry 48 retrieves the alternate path prediction from the alternate path cache 46. At step 112, the block skipping circuitry 48 identifies the prediction resumption address for a subsequent block of instructions, based on the alternate path prediction. It will be appreciated that information of the alternate path prediction may also be communicated to the fetch stage 6, which restarts fetching instructions after the mispredicted branch instruction based on the alternate path of program flow. At step 114, the block skipping circuitry 48 controls the branch predictor 40 to restart generating predictions at the prediction resumption address.

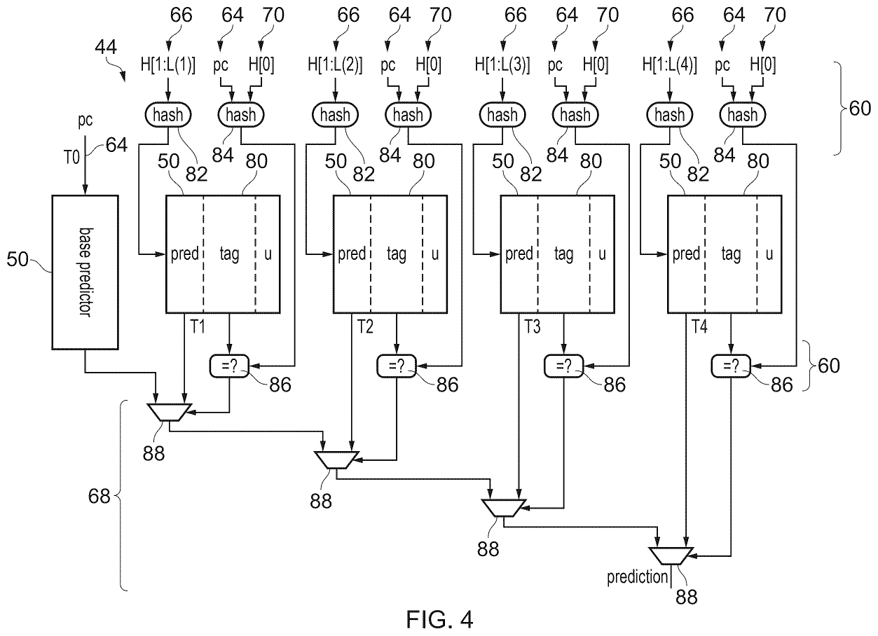

FIG. 4 shows a specific example of a prediction mechanism that may be implemented into the branch predictor 40, e.g. as the BDP 44. The prediction mechanism is a tagged-geometric (TAGE) predictor for which the branch prediction tables 50 include a base prediction table T0 and a number of TAGE tables T1 to T4, which are each arranged as set-associative storage structures. While this example shows 4 TAGE tables for conciseness, it will be appreciated that the TAGE predictors could be provided with a larger number of tables if desired, e.g. 8 or 16. The base predictor T0 is indexed based on the program counter PC 64 alone, while the TAGE tables T1 to T4 are indexed based on a hash value generated by applying a hash function 82 to successively increasing lengths of history information 66, so that T1 uses a shorter sequence of history information compared to T2, T2 uses a shorter sequence of history information compared to T3, and so on. In this example, T4 is the table which uses the longest sequence of history information.

The index generated by the hash function 82 is used to select which particular entry of the TAGE table 50 is read when looking up the tables 50. The history information 66 used to generate the index value is derived from the program flow history tracked by the history tracking circuitry 125 discussed above, and comprises information on recently predicted branch instructions that have fulfilled a program flow history update condition (e.g. branch instructions that were predicted taken, in some specific examples). For the purposes of indexing, the history information 66 excludes a most recently predicted branch instruction satisfying the program flow history update condition. For example, if the program flow history update condition is satisfied only for taken branch instructions, the index is independent of information relating to a most recently predicted branch instruction. Hence, where the program flow history was updated based on branches A, B, C, and D, the portion of the program flow history used as history information 66 for generating the index value used may only represent information about branches A, B, and C and excludes information about branch D. Prediction entries in the corresponding set may therefore indicate prediction information relating to a history of A, B, C, and D and A, B, C, and D′ (where D′ indicates a different branch to branch D, which might arise following differences in predicted outcomes for one of branches C or D or an intervening branch). Accordingly, it is possible to identify two or more prediction entries in a single lookup of each TAGE table, which each relate to a shared earlier portion of program flow history (e.g. the history corresponding to branches A, B and C) but which then diverge (e.g. with differences between branch D and branch D′), and hence two or more predictions may be generated relating to alternate paths that are possible around a given point of program flow.

Hence, in this example, the index for table T1 is based on history information H[1:L(1)], the index for table T2 is based on history information H[1:L(2)], the index for table T3 is based on history information H[1:L(3)], and the index for table T4 is based on history information H[1:L(4)], where L4>L3>L2>L1 so that each TAGE table uses a progressively longer sequence of history, but the index for each table is generated based on information excluding the entry H[0] representing the most recent predicted branch that caused the history to be updated.

Each prediction entry specifies a prediction counter (“pred”), for example a 2-bit counter which provides a bimodal indication of whether the prediction is to be taken or not taken (e.g. counter values 11, 10, 00, 01 may respectively indicate predictions of: strongly predicted taken, weakly predicted taken, weakly predicted not taken, and strongly predicted not taken). Each entry also specifies a tag value 80 which is compared with a tag hash generated in dependence on an indication of the current block of instructions, i.e. the PC 64, and the history information 70 relating to the most recently predicted branch instruction, i.e. branch D from the above example. In FIG. 4, the most recently predicted branch instruction is represented by H[0], which is not included in the history information 66 used in indexing but is used for the tag generation hash 84. While in this example the tag hash does not depend on other entries of the history tracked by history tracking circuitry 125 (entries H[1] onwards of the history information are used for the index hash 82 but not the tag hash 84), other examples could also consider one or more of history entries H[1] onwards in the tag hash function).

The tag hash is used distinguish between multiple prediction entries whose index hash values alias onto the same set of the table. The lookup circuitry includes index hashing circuitry 82 for generating the index hash for indexing into a selected set of the table, tag hashing circuitry 84 for generating a tag hash value to be written to a newly allocated prediction entry or for comparing with an existing prediction entry's tag value 80 on a lookup, and comparison circuitry 86 for comparing the tag value 80 read out from a looked up entry with the calculated tag hash generated by the tag hashing circuitry 84 to determine whether a hit has been detected.

For a TAGE predictor, the TAGE prediction generating circuitry 68 comprises a cascaded sequence of selection multiplexers 88 which select between the alternative predictions returned by any of the prediction tables 50 which generate a hit. The base predictor 50 may always be considered to generate a hit, and is used as a fall-back predictor in case none of the other TAGE tables generate a hit (a hit occurs when the tag in the looked up entry matches the tag hash generated based on the indexing information). The cascaded multiplexers are such that if the table T4 indexed with the longest sequence of history generates a hit then its prediction will be output as the prediction result, but if it misses then if the preceding table T3 generates a hit then the T3 prediction will be output as the overall prediction for the current block, and so on, so that the prediction which gets selected is the prediction output by the table (among those tables which generated a hit) which corresponds to the longest sequence of history considered in the indexing. That is, any tables which miss are excluded from the selection, and among the remaining tables the one with the longest sequence of history in its indexing information is selected, and if none of the TAGE tables T1 to T4 generate a hit then the base predictor T0 is selected.

This approach is extremely useful for providing high performance because a single table indexed with a fixed length of branch history has to trade off the accuracy of predictions against the likelihood of lookups hitting in the table. A table indexed with a relatively short sequence of branch history may be more likely to generate a hit, because it is more likely that the recently seen history leading to the current block is the same as a previously seen sequence of history for which an entry is recorded in the table, but as the shorter sequence of history cannot distinguish as precisely between the different routes by which the program flow may have reached the current block, it is more likely that the prediction indicated in the hit entry may be incorrect. On the other hand, for the table T4 which is indexed based on the longest sequence of history, this can be extremely useful for predicting harder to predict branches which need to delve further into the past in terms of exploring the history so that that the pattern of program execution which led to that branch can be characterised and an accurate prediction made, however, it is less likely on subsequent occasions that the longer sequence of history will exactly match the sequence of history leading up to the current block and so the hit rate is lower in a table indexed based on a longer sequence of history. By providing a range of tables with different lengths of history used for indexing, this can balance these factors so that while the hardest to predict branches which would be difficult to predict using other branch predictors can be successfully predicted with the longer table T4, other easier to predict branches which do not require the full prediction capability of T4 can be predicted using one of the earlier tables indexed based on shorter history so that it is more likely that a hit will be detected on a prediction lookup, thus increasing the percentage of branches for which a successful prediction can be made and therefore improving prediction accuracy and performance. Hence, TAGE predictors are one of the most accurate predictors known.

By indexing the TAGE tables T1 to T4 independently of information H[0] relating to a most recently predicted branch instruction satisfying the program flow history update condition, a single lookup of the TAGE predictor can hit on an indexed set comprising two or more prediction entries which are likely to relate to alternate paths of program flow which might be useful if the main path prediction turns out to be incorrect. A prediction entry to be used for generating the main path prediction is identified by comparing the tag hash value, which is dependent on information relating to a most recently predicted branch instruction. An entry that does not match the tag hash value (but does match the index hash) may relate to a different branch instruction (e.g. in a different block of instructions), but has a similar history of predicted branches (excluding the most recent branch satisfying the program flow history update condition). Hence, such an entry may be used for generating an alternate path prediction without incurring the latency of an additional lookup of the full TAGE structure, by caching the alternate path prediction for use when recovering from a flush.

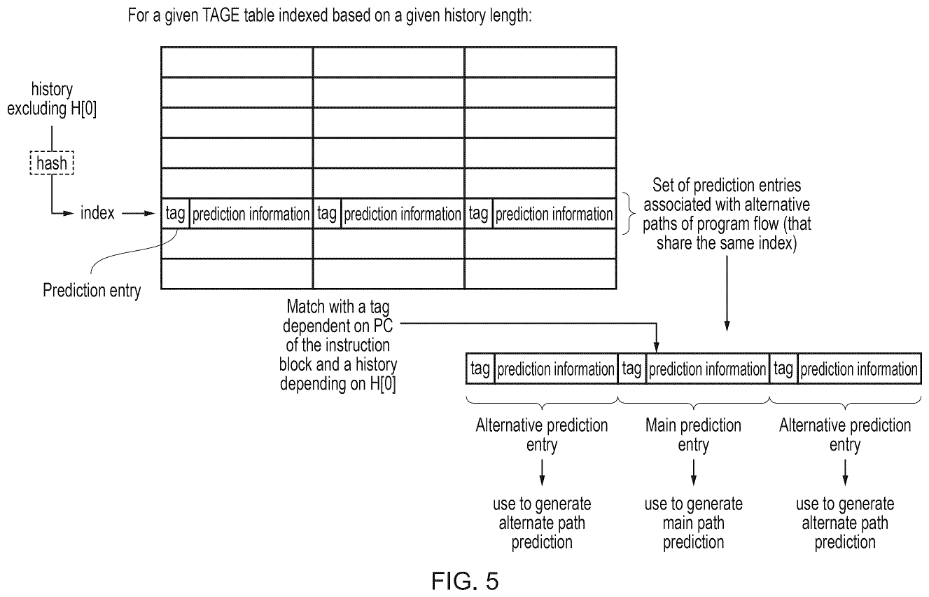

FIG. 5 illustrates a set that may be hit in one of the TAGE tables T1 to T4. The history excluding H[0] (the information on the most recent predicted branch satisfying the program flow update condition) is hashed by the index hashing circuitry 82 to obtain an index to the TAGE table. In this example, the index hits on a set containing three prediction entries (three entries are shown for conciseness, but in practice the number of entries in one set may be a power of 2). Each entry in the set may be indicative of different paths of program flow. Each prediction entry is also stored in association with a respective tag value. The tag values are compared with a tag generated by the tag hashing circuitry 84 based on the PC 64 and information H[0] relating to the most recently predicted branch instruction that satisfied the program flow history update condition, to identify the prediction entry to be used for generating the main path prediction. The other remaining prediction entries (i.e. that matched the index, but did not match the tag) may then be used for generating alternate path predictions.

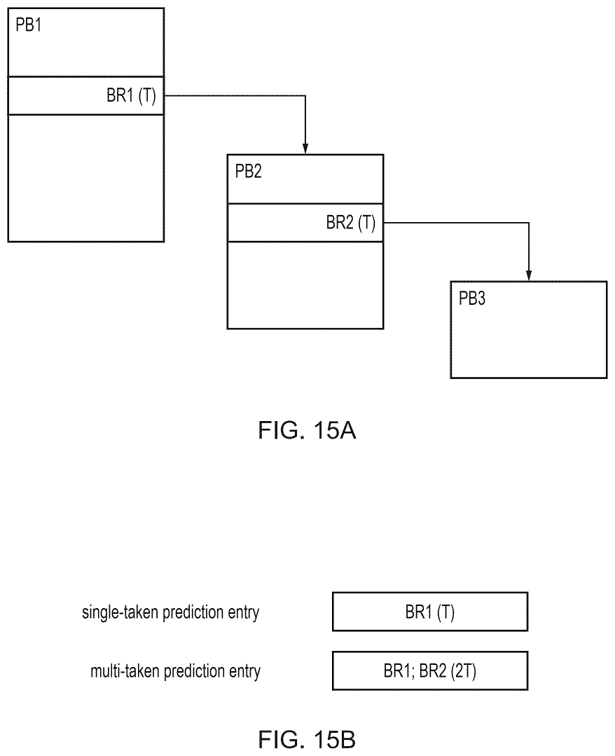

Among the remaining prediction entries for generating alternate path predictions, some examples may include prediction entries that support an encoding of a multi-taken entry indicative of a sequence of two or more branch instructions that are each predicted to be taken. FIG. 15A illustrates one an example of program flow that may cause a multi-taken entry to be stored, e.g. in one of the TAGE tables T1 to T4. The program flow begins in PB1 and a branch instruction BR1 is taken, targeting PB2. PB2 then contains branch instruction BR2, which is taken, targeting PB3. When such a program flow is observed, the table updating circuitry 120 may update the prediction entries in one of the TAGE tables to contain a multi-taken entry.

FIG. 15B illustrates an example to contrast the data that may be included in different types of entries. In a single-taken prediction entry (e.g. where the prediction entry identifies a predicted outcome for one branch instruction), the prediction entry comprises an indication of the predicted direction (i.e. taken, T) in association with an identifier of the branch instruction BR1. As mentioned previously, the identifier of the branch instruction may be contained in a tag. It will be appreciated that to provide prediction information for the program flow of FIG. 15A, one additional single-taken prediction entry will be required to indicate that BR2 is also to be taken.

In a multi-taken prediction entry (e.g. where the prediction entry identifies a predicted outcome for multiple branch instructions), the prediction entry comprises an indication of outcomes of multiple branch instructions. In this case, the entry relates to both BR1 and BR2, which are both predicted to be taken. Hence, the predicted direction indicates two-taken (2T). The multi-taken entry may still be tagged with BR1, such that when looking up a prediction in respect of BR1, prediction information for BR1 and BR2 can be obtained in the same lookup. It is possible that there could also be a separate single-taken prediction entry (with index and tag corresponding to BR2) located at a different location in the TAGE tables from the multi-taken prediction entry whose index/tag corresponds to BR1.

It will be appreciated that while the present techniques may include the index being independent of the most recently predicted branch instruction satisfying the program flow history update condition, more aggressive examples may use an index that is independent of information relating to the N most recently predicted branch instructions satisfying the program flow history update condition, where N is an integer greater than 1. This causes the set-associative structures to hit on more entries thereby allowing for more predictions, at the cost of accuracy. This may allow further identification of alternate paths that encompass a greater number of branches ahead of the point at which a misprediction is detected.

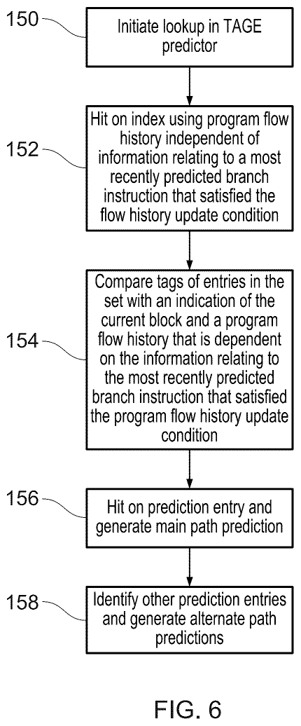

FIG. 6 illustrates a sequence of steps for using a TAGE predictor for generating a main path prediction and an alternate path prediction. The process begins at step 150 in which a (single) lookup is initiated in the TAGE predictor. Initiating a lookup may include generating hash values for the index hash and/or tag hash based on the PC 64 and the history information 66, 70 tracked by the history tracking circuitry 125. At step 152, a hit is detected on an index using the program flow history independent of information relating to a most recently predicted branch instruction that satisfied the program flow history update condition. The hit identifies a set in the set-associative TAGE tables, where the set contains two or more prediction entries. At step 154, the tags of each prediction entry in the set are compared with a tag value generated based on the current block and a program flow history that is dependent on the information relating to the most recently predicted branch instruction that satisfied the program flow history update condition. If there is a hit on the tag value comparisons, then at step 156, the main path prediction is generated based on the hit prediction entry. At step 158, any other prediction entries in the set are used to generate at least one alternate path prediction, which is then stored in the alternate prediction cache 46 as in previous examples.

It will be appreciated that where there are multiple hit prediction entries in the branch predictor 40, alternate path predictions may be generated based on each hit prediction entry. While this provides a comprehensive overview of how the path of program flow might change if the main path prediction is incorrect, excessive pressure may be experienced by the alternate prediction cache as all of the alternate path predictions are stored. Accordingly, of the alternate path predictions that may be generated, those that correspond to a previously observed path after the branch instruction are permitted to be stored in the alternate prediction cache 46. This therefore limits the alternate path predictions to those that are more likely to be accurate.

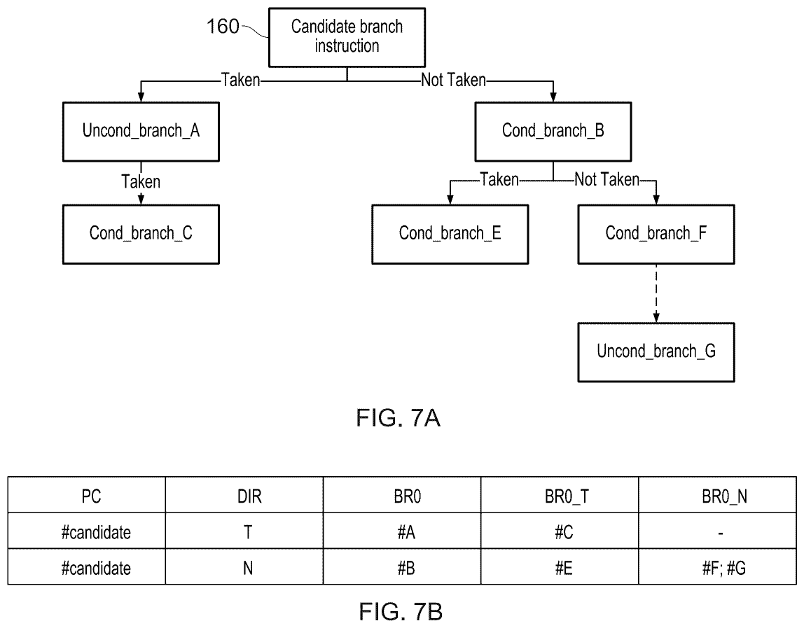

For this purpose, the apparatus 2 may be provided with flow tracking circuitry 52, in which program flow information indicative of one or more observed paths after a candidate branch instruction is maintained. The program flow information may be represented as a graph, an example of which is shown in FIG. 7A. A candidate branch instruction 160 is selected for flow tracking, from which the program flow has previously been observed to follow a taken path and a not taken path. Further points of program flow are added in response to further predictions being generated and/or outcomes of branches being resolved at the execute stage 16. For example, following the not taken path from the candidate branch instruction 160, the program flow encounters a conditional branch instruction B, for which the prediction circuitry 40 generates a prediction. Hence, branch instruction B is added to the observed path of program flow, which then divides into another taken path and not taken path to encounter the conditional branch instructions E and F respectively, which are similarly added to the program flow when predictions are generated in respect of branches E and F.

It will be appreciated that the program may also include unconditional branches. As shown, the taken path from the candidate branch instruction 160 encounters an unconditional branch instruction A, for which the prediction circuitry 40 does not need to generate a prediction. Nonetheless, the unconditional branch instruction A may be identified and added to the observed path of program flow, which then continues to a taken path to encounter the conditional branch instruction C, which is similarly added to the program flow when a prediction is generated in respect of branch C.

It will be appreciated that the depth of the graph, corresponding to the length of the observed paths, may be limited to reduce the capacity required to maintain the program flow information. However, if an observed path is at the limit but then encounters an unconditional branch such as unconditional branch G, then the flow tracking information may include the unconditional branch at low cost, because the flow tracking circuitry 52 does not need to wait for predictions to be generated. For example, information identifying the unconditional branch may be appended to the entry of program flow information.

Each observed path from the candidate branch instruction 160 may be represented as one entry of program flow information. For example, each entry may contain information specifying: the program counter address of the candidate branch instruction 160, an observed outcome (taken or not taken) of the candidate branch instruction, the target address of the candidate branch if taken, and similarly information for one or more subsequent branch instructions. FIG. 7B illustrates an example of how the graph of FIG. 7A can be stored as entries of program flow information. The field BR0 is indicative of an address of the next branch encountered after the observed outcome (DIR) from the candidate branch instruction 160. The values for BR0_T and BR0_N then further indicate addresses of subsequent branches encountered for taken and not-taken outcomes of the branch instruction identified by BR0. It will be appreciated that further information may be included, e.g. BR1_T and BR1_N that may indicate the branches encountered after branch E. Also, FIG. 7B shows an example where information about an unconditional branch #G is included in the field BR0_N showing the program flow subsequent to branch B being not taken.

In some examples, the flow tracking circuitry 52 may maintain program flow information indicative of one or more observed paths after a polymorphic branch instruction. A polymorphic branch instruction is a branch instruction that, when taken, can lead to a plurality of different target addresses. Hence, there could be a larger number of possible observed paths after a polymorphic branch instruction leading to each possible taken path.

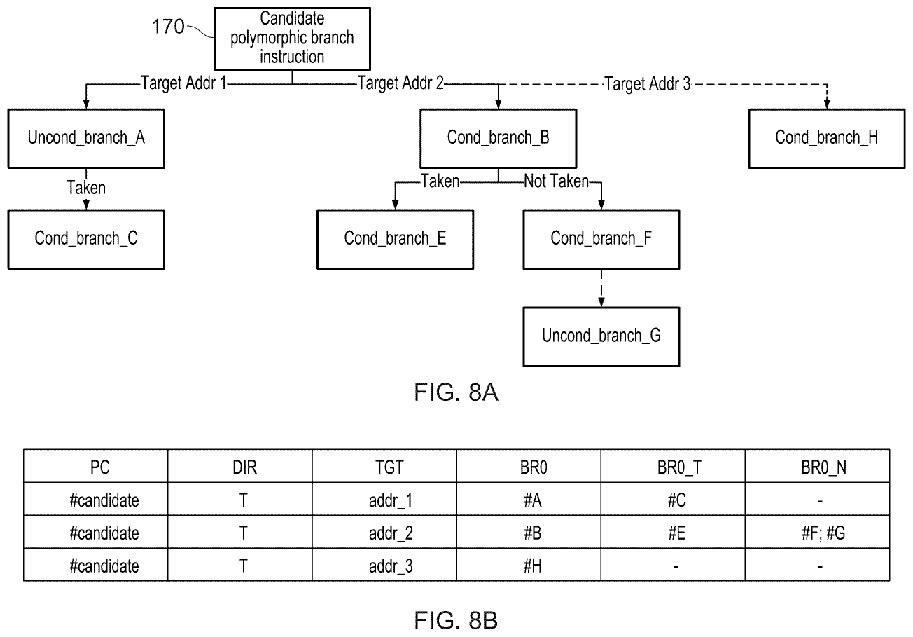

FIG. 8A illustrates a graph representing program flow information for a candidate polymorphic branch instruction 170. In this example, the candidate polymorphic branch instruction 170 has been observed to follow two taken paths to target address 1 and target address 2. Further points of program flow may also be added in a similar way as described with reference to FIG. 7A, such that conditional branch instructions A to G may also be included on the observed paths. Further observed paths may include the candidate polymorphic branch instruction following a taken path to target address 3, which then encounters a conditional branch instruction H. Hence, it will be appreciated that the candidate polymorphic branch instruction can follow a plurality of different taken paths, which then result in a different conditional branch instructions being encountered on each observed path. Some examples may focus the flow tracking functionality on polymorphic branches with a low number of possible target addresses to avoid excessive complexity in the program flow information. Some examples may also replace some observed paths with newer ones such that the program flow information identifies some of the most recently observed target addresses.

FIG. 8B illustrates how entries of program flow information may be stored in the flow tracking circuitry 52. In particular, when tracking polymorphic branch instructions, an additional field (TGT) may be used to indicate the target address of the observed branch, to allow the relevant path of program flow to be identified when the target address of the polymorphic branch is resolved or predicted.

The flow tracking circuitry 52 may be used to control which alternate path predictions are permitted to be stored in the alternate prediction cache 46. For example, when an alternate path prediction is generated e.g. using the TAGE predictor described previously, the flow tracking circuitry 52 is configured to determine whether any of the observed paths correspond to the alternate path prediction. If so, then that alternate path prediction is considered more likely to be accurate and hence is permitted to be stored in the alternate prediction cache 46. On the other hand, an alternate path prediction that does not correspond to any of the observed paths may not be permitted to be stored in the alternate prediction cache 46.

It will be appreciated from the above description of the flow tracking circuitry 52 that the amount of program flow information that is generated will depend on how the candidate branch instruction 160 (or candidate polymorphic branch instruction 170) is selected. Some examples may select the candidate branch instruction by detecting a branch instruction that is hard to predict. For example, a branch instruction that results in frequent mispredictions may be considered hard to predict and hence selected as a candidate branch instruction by the flow tracking circuitry. Frequent mispredictions may be monitored by storing values indicative of a misprediction rate relating to each branch instruction. In examples comprising the BTB 42, a confidence value may already be stored in relation to different branch predictions. The confidence value may be used for one or more other functions, in which case the same value can be reused for determining whether the branch instruction has a low confidence (indicative of a high misprediction rate) and hence hard to predict. The flow tracking circuitry 52 may determine whether a misprediction rate exceeds a threshold value, in which case that branch instruction may be selected as a candidate branch instruction for generating program flow information.

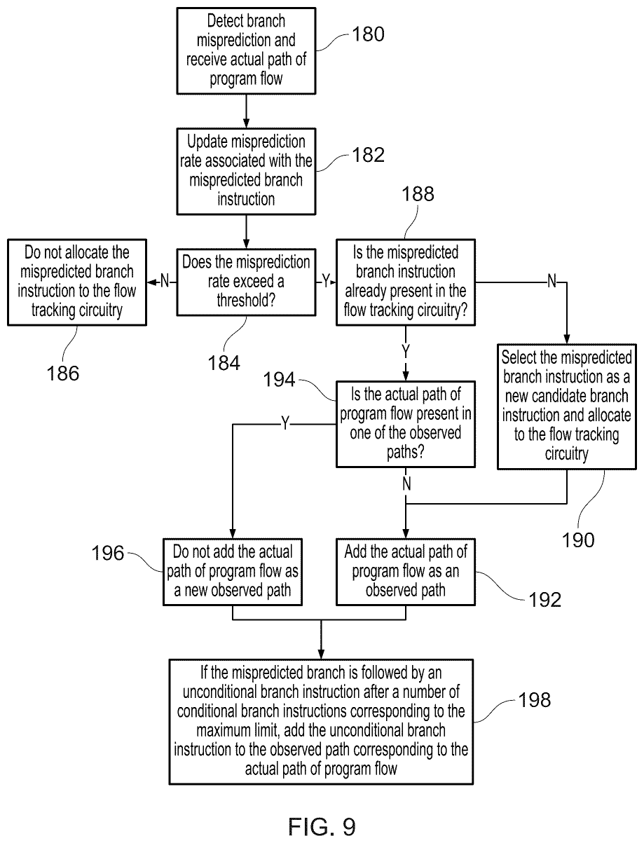

FIG. 9 illustrates a sequence of steps for allocating or updating observed paths of program flow by the flow tracking circuitry 52. At step 180 a branch misprediction is detected, and the actual path of program flow is received, for example from the branch unit 24. At step 182, the misprediction rate associated with the mispredicted branch instruction is updated to represent the occurrence of a misprediction. At step 184, it is determined whether the misprediction rate exceeds a threshold value. If not, then the flow tracking circuitry 52 does not consider that the branch instruction is sufficiently hard to predict. Hence, at step 186, the mispredicted branch instruction is not allocated to the flow tracking circuitry 52.

On the other hand, if the misprediction rate does exceed the threshold value, then the flow tracking circuitry 52 considers that the branch instruction is sufficiently hard to predict. Hence, at step 188, it is determined whether the branch instruction is already present (i.e. already being tracked) by the flow tracking circuitry 52. If not, then the mispredicted branch instruction is to be selected as a new candidate branch instruction and allocated to an entry of the flow tracking circuitry 52. Then at step 192, the actual path of program flow received in step 180 is entered as one of the observed paths of program flow.

Returning to step 188, if the mispredicted branch instruction is already present in the flow tracking circuitry 52, then at step 194, it is determined whether the actual path of program flow received in step 180 is already present in one of the observed paths. If not, then the actual path of program flow is added as a new observed path at step 192. However, if the actual path of program flow is already present in one of the observed paths, then no update to the program flow information is required, and at step 196 the actual path of program flow is not added as a new observed path.

After the update process is complete, at step 198, it may be determined whether the mispredicted branch instruction is followed by an unconditional branch instruction after a number of conditional branch instructions corresponding to the maximum limit. If so, then the entry of program flow information can have information identifying the unconditional branch appended to it, such that the unconditional branch instruction is added to the observed path corresponding to the actual path of program flow.

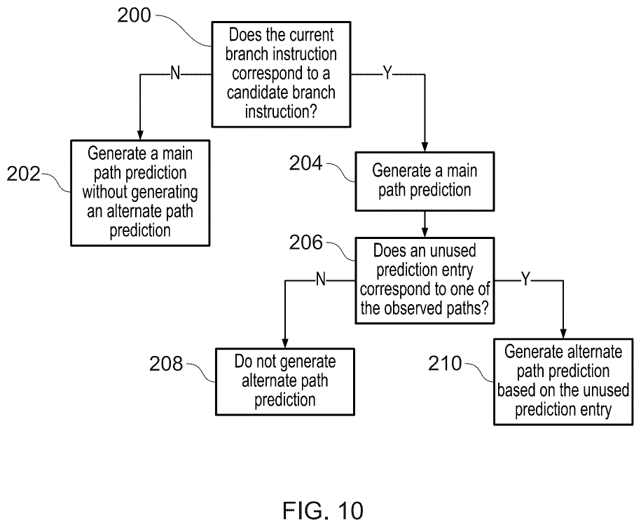

After the flow tracking circuitry 52 has tracked the observed paths for the candidate branch instruction, the program flow information may then be used for controlling the allocation of alternate path predictions to the alternate prediction cache 46. FIG. 10 illustrates a sequence of steps for how the program flow information may be used by the branch predictor 40. At step 200 it is determined whether the current branch instruction for which a prediction is being generated corresponds to a candidate branch instruction having a corresponding entry tracked by the flow tracking circuitry 52. If not, then at step 202, the branch predictor 40 generates a main path prediction without generating an alternate path prediction. If the current branch prediction does correspond to a candidate branch instruction tracked by the flow tracking circuitry 52, then at step 204, a main path prediction is generated based on a prediction entry. At step 206, another prediction entry (e.g. in the same set of one of the set-associative TAGE tables as described previously, but not matched against the tag and hence not used to generate the main path prediction) is compared against one of the observed paths represented by the entry of the flow tracking circuitry 52 corresponding to the candidate branch instruction. If they do not correspond with each other, then at step 208, the alternate path prediction is not generated and hence not stored in the alternate prediction cache 46. If the unused prediction entry obtained from the branch predictor 40 does correspond to one of the observed paths tracked for the candidate branch instruction in the flow tracking circuitry 52, then the branch predictor 40 generates the alternate path prediction and stores it in the alternate prediction cache 46 for use by the block skipping circuitry 48.

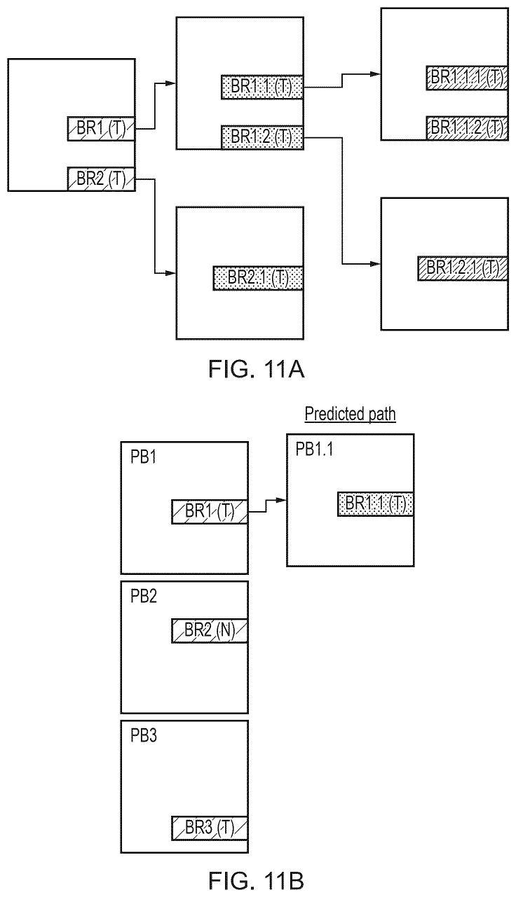

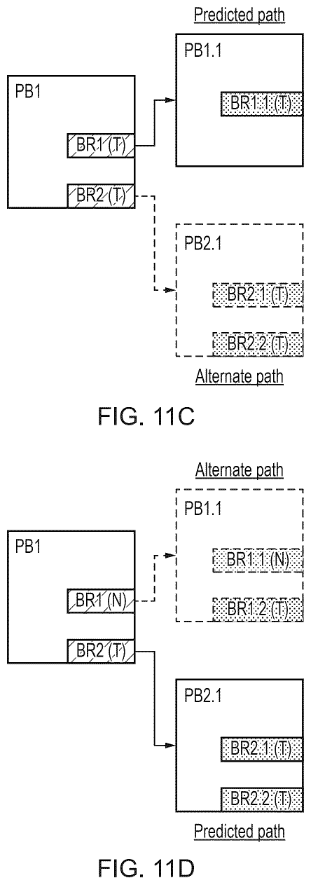

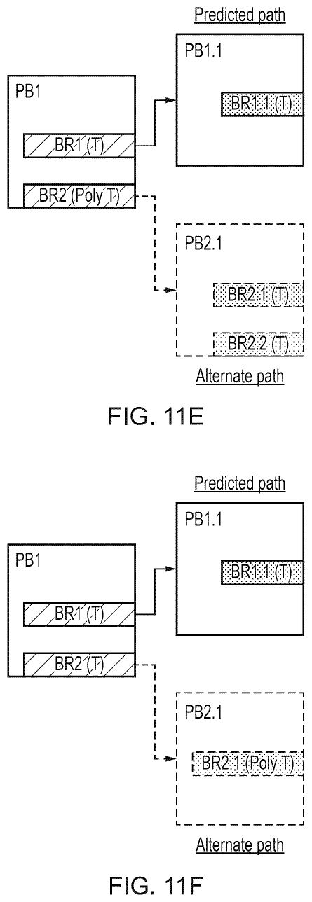

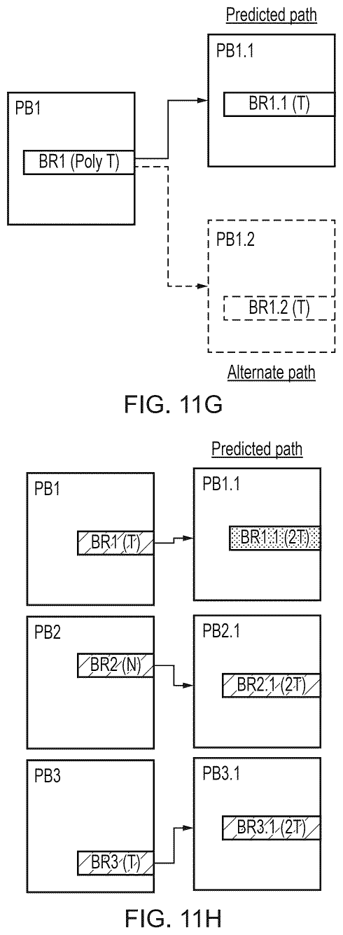

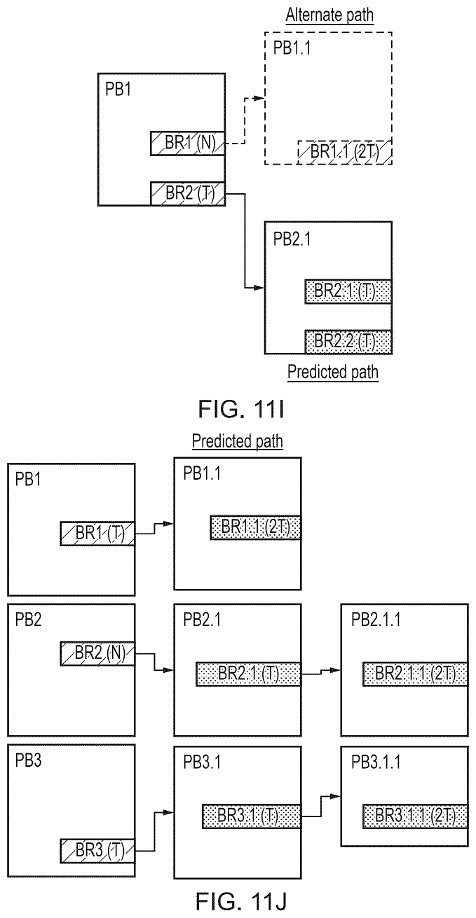

The following is a series of examples where alternate path predictions are generated and how block skipping circuitry 48 may generate a prediction resumption address in response to a flush signal. These examples are based on a specific example in which the program flow history update condition is satisfied when a predicted branch is taken, but is not satisfied for not-taken predicted branches. It will be appreciated that other examples could use a different program flow history update condition, in which case the pattern of which branches share the same index value may differ from that shown in the examples of FIGS. 11A to 11G.

FIG. 11A illustrates how different paths of program flow may be predicted based on entries sharing the same index in the TAGE tables. In this example, BR1.1, BR1.2, BR2.1 will share the same index value because the history information used to generate the index for these branch lookups will exclude information on the most recent taken branch (BR1 for BR1.1 and BR1.2, and BR2 for BR2.1—note that to reach BR1.2, BR1.1 must be not-taken so does not count as a most recent taken branch when looking up information for BR1.2). Similarly, the entries for branches BR1.1.1, BR1.1.2, BR1.2.1 share the same index because their index hash excludes information relating to the most recent taken branch BR1.1 or BR1.2.

While allocating such entries to the same set can cause additional pressure on the TAGE as multiple paths map to the same set, this can be useful to peek into alternate paths without requiring any additional TAGE lookup, as demonstrated by the subsequent examples.

FIG. 11B illustrates an example where the branch predictor 40 generates a main path prediction in respect of processing block (PB) 1. The branch instruction BR1 is predicted to be taken with a target address in PB1.1. An alternate path prediction is further generated in respect of the path of program flow if BR1 is later resolved as not taken. In particular, the alternate path of program flow includes BR2 being not taken and BR3 being taken. Prior to BR1 being evaluated, e.g. by the branch unit 24, the branch predictor 40 may further generate predictions in respect of BR1.1.

The alternate path prediction may be stored in association (e.g. tagged) with other information such that the block skipping circuitry 48 is able to use the correct alternate path prediction and to restart the fetching of instructions in the event of a flush. For example, the alternate path prediction may be stored in association with any one or more of an identifier of the block PB1, an offset of BR1 within PB1, or an alternate direction indicative of what outcome of BR1 corresponds to the alternate path prediction, i.e. taken (T) or not taken (N). Hence, in this example, an entry of the alternate path prediction cache 46 may indicate: [PB1; BR1_offset; N; BR2(N); BR3(T)], to indicate that this alternate path applies when the branch in PB1 and offset BR1_offset is not taken, and indicates that the subsequent flow is predicted to include a not taken branch BR2 followed by a taken branch BR3.

If a flush signal is received indicative of the main path prediction of BR1 being incorrect (i.e. BR1 is actually not taken), the block skipping circuitry 48 may lookup the alternate prediction cache 46 using information about BR1 and the actual outcome (N) received from the branch unit 24 to identify the alternate path prediction. The offset of BR1 and other alternate path information BR2(N), BR3(T) may be sent to the fetch stage 6 so that the fetching of instructions can begin from the address following BR1 in PB1 and continuing with the instructions of PB2 and PB3 up to BR3 in PB3. Meanwhile, the block skipping circuitry 48 identifies the prediction resumption address based on the alternate path prediction. For example, the prediction resumption address may be identified as the target address of BR3, and the branch predictor 40 is controlled to begin generating predictions from that address. Hence, the bubble of fetching that would have arisen if predictions had to resume from BR1 can be avoided by resuming predictions from the target of BR3 and fetching the intervening instructions based on the cached alternate path information.

FIG. 11C illustrates an example where PB1 contains two branch instructions BR1 and BR2. The main path prediction includes BR1 being taken with a target address in PB1.1. An alternate path prediction is further generated in respect of the path of program flow if BR1 is later resolved as not taken. In particular, the alternate path of program flow includes BR2 being taken with a target address in PB2.1. As in previous examples, the alternate path prediction is stored in the alternate prediction cache 46.

In this example, the main path prediction and alternate path prediction are both extended by generating further predictions in respect of BR1.1, BR2.1, and BR2.2. For example, as described previously in relation to FIG. 4, a set-associative storage structure may be looked up using an index independent of the most recently predicted branch instruction satisfying the program flow history update condition (i.e. BR1), thereby hitting on prediction entries corresponding to each of BR1.1, BR2.1, and BR2.2 in a single lookup. The extended main path prediction is used to further control the fetch stage 6 to continue fetching instructions. The extended alternate path prediction is also stored in the alternate prediction cache 46, for example as an extension of the same alternate prediction cache entry as stored previously.

As above, the alternate path prediction is stored in the alternate prediction cache 46 with various tagging information. For example, an entry of the alternate prediction cache 46 may indicate: [PB1; BR1_offset; N; BR2(T); BR2.1(T)].

If a flush signal is received indicative of the main path prediction of BR1 being incorrect, the block skipping circuitry 48 may lookup the alternate prediction cache 46 as described above to identify the prediction resumption address and to identify the sequence of instructions to be fetched up to the point at which predictions resume. For example, the prediction resumption address may be identified as the target address of BR2.1, and the branch predictor 40 is controlled to begin generating predictions from that address.

FIG. 11D illustrates a similar example to FIG. 11C, but where the main path prediction instead includes BR1 being not taken. Hence, the main path of program flow continues to BR2 which is predicted to be taken with a target address in PB2.1. An alternate path prediction is generated in respect of the path of program flow if BR1 is later resolved as taken. In particular, the alternate path of program flow includes a target address in PB1.1. As in previous examples, the alternate path prediction is stored in the alternate prediction cache 46.

In this example, the main path prediction and alternate path prediction are both extended by generating further predictions in respect of BR1.1, BR1.2, BR2.1 and BR2.2. The extended main path prediction predicts that BR2.1 is to be taken and the alternate path prediction includes BR1.1 being not taken, and BR1.2 being taken.

As above, the alternate path prediction is stored in the alternate prediction cache 46 with various tagging information. In this example, an entry of the alternate prediction cache 46 may indicate: [PB1; BR1_offset; T; BR1.1(N); BR1.2(T)].

If a flush signal is received indicative of the main path prediction of BR1 being incorrect, the block skipping circuitry 48 may lookup the alternate prediction cache 46 as described above to identify the prediction resumption address and to identify the sequence of instructions to be fetched up to the point at which predictions resume. For example, the prediction resumption address may be identified as the target address of BR1.2, and the branch predictor 40 is controlled to begin generating predictions from that address.

FIG. 11E illustrates an example where PB1 contains a polymorphic branch instruction, BR2 in the alternate path of program flow. In particular, the main path prediction includes BR1 being taken with a target address in PB1.1. The alternate path prediction is generated in respect of BR1 being not taken, and then encountering BR2. The alternate path prediction then represents a polymorphic prediction with a particular target address in PB2.1. The main path prediction and alternate path prediction are both extended by generating further predictions in respect of BR1.1, BR2.1, and BR2.2. The extended main path prediction predicts that BR1.1 is to be taken, and the alternate path prediction includes BR2.1 being taken.

In addition or alternatively to the various tagging information described above, the alternate path prediction may be further stored in association with the target address identified in the polymorphic prediction. Therefore, in this example, an entry of the alternate prediction cache 46 may indicate: [PB1; BR1_offset; N; BR2(PB2.1); BR2.1(T)]. This can distinguish the alternate path prediction from other outcomes relating to different target addresses for the polymorphic branch BR2.

If a flush signal is received indicative of the main path prediction of BR1 being incorrect, the block skipping circuitry 48 may look up the alternate prediction cache 46 as described above to identify the prediction resumption address and the instruction fetch sequence. For example, the prediction resumption address may be identified as the target address of BR2.1, and the branch predictor 40 is controlled to begin generating predictions from that address.

FIG. 11F illustrates an example where the alternate path prediction contains a polymorphic branch instruction with an intervening branch instruction. In particular PB1 contains BR1 and BR2, where a main path prediction includes BR1 being taken with a target address in PB1.1. The alternate path prediction, generated in respect of BR1 being not taken, includes BR2 being taken with a target address in PB2.1, which further contains a polymorphic branch instruction, BR2.1.

The alternate path may be extended as above when generating the main path prediction in respect of BR1.1, in order to identify a target address, PB2.1.1 (not illustrated) of the polymorphic branch instruction BR2.1. The alternate path prediction may then be stored in the alternate prediction cache 46 with the various tagging information described above. Therefore, in this example, an entry of the alternate prediction cache 46 may indicate: [PB1; BR1_offset; N; BR2(T); BR2.1(PB2.1.1).

If a flush signal is received indicative of the main path prediction of BR1 being incorrect, the block skipping circuitry 48 may lookup the alternate prediction cache 46 as described above to identify the prediction resumption address and instruction fetch sequence. For example, the prediction resumption address may be identified as the target address of BR2.1, and the branch predictor 40 is controlled to begin generating predictions from that address.

FIG. 11G illustrates an example where the main path prediction is being generated in respect of a polymorphic branch instruction. In this example, BR1 is unconditionally taken, but may target different target addresses in PB1.1 or PB1.2. A main path prediction includes the target address being PB1.1. Hence, an alternate path prediction can be generated in respect of the main path prediction being incorrect, i.e. targeting PB1.2 instead.

Where the above examples include tagging the alternate path prediction with the alternate direction, in this example, the direction in both the main and alternate path predictions is the same, i.e. the branch is taken in both. Therefore, for the block skipping circuitry 48 to identify the alternate path prediction for BR1, the alternate path prediction may further be tagged by the target address instead of or in addition to the alternate direction. For example, the prediction resumption address may indicate: [PB1; BR1_offset; PB1.2; BR1.2 (T)].

If a flush signal is received indicative of the main path prediction of BR1 being incorrect, the block skipping circuitry 48 may lookup the alternate prediction cache 46 as described above to identify the prediction resumption address and instruction fetch sequence. For example, the prediction resumption address may be identified as the target address of BR1.2, and the branch predictor 40 is controlled to begin generating predictions from that address.

FIG. 11H illustrates an example where the alternate path prediction is generated based on a multi-taken entry. In particular, PB1 contains BR1 and a main path prediction includes BR1 being taken with a target address in PB1.1. The alternate path prediction, generated in respect of BR1 being not taken, includes BR2 being not taken, and BR3 being taken. In this example, the prediction entry used for generating the prediction for BR3 is a multi-taken entry. Therefore, as part of the same lookup (i.e. in the BDP 44), it is further predicted that BR3.1 is to be taken.

Also in this example, a prediction can be generated in respect of BR2.1. BR2.1 is not included in the alternate path prediction because BR2 is predicted to be not taken, but it will be appreciated that if BR2 were to be taken, then BR2 and BR2.1 could be compressed into a multi-taken entry.

The alternate path prediction may be stored in the alternate prediction cache 46 as described above, and may include additional fields to specify the additional branch instructions that have been predicted as a result of using a multi-taken entry. In this example, an entry of the alternate prediction cache 46 may indicate: [PB1; BR1_offset; N; BR2(N); BR3(T); BR3.1(T)].

If a flush signal is received indicative of the main path prediction of BR1 being incorrect, the block skipping circuitry 48 may lookup the alternate prediction cache 46 as described above to identify the prediction resumption address and to identify the sequence of instructions to be fetched up to the point at which predictions resume. For example, the prediction resumption address may be identified as the target address of BR3.1, and the branch predictor 40 is controlled to begin generating predictions from that address.

FIG. 11I illustrates an example where the main path prediction includes BR1 being not taken and BR2 being taken. The main path prediction may be extended with an additional lookup to predict the branch instructions BR2.1 and BR2.2 in PB2.1. An alternate path prediction is generated in respect of the path of program flow if BR1 is later resolved as taken. In this example, the alternate path prediction is generated based on a multi-taken entry indicative that both BR1 and BR1.1 are to be taken. Therefore, as above, the alternate path of program flow is identified in one lookup.

As above, the alternate path prediction is stored in the alternate prediction cache 46 with various tagging information. In this example, an entry of the alternate prediction cache 46 may indicate: [PB1; BR1_offset; T; BR1.1(T)].

If a flush signal is received indicative of the main path prediction of BR1 being incorrect, the block skipping circuitry 48 may lookup the alternate prediction cache 46 as described above to identify the prediction resumption address and to identify the sequence of instructions to be fetched up to the point at which predictions resume. For example, the prediction resumption address may be identified as the target address of BR1.2, and the branch predictor 40 is controlled to begin generating predictions from that address.

FIG. 11J illustrates an example where the alternate path prediction can be further extended using a second lookup for a multi-taken entry. In this example, the main path prediction includes BR1 being taken. Hence, in the same lookup the alternate path prediction can be generated in respect of BR1 being not taken, thereby encountering BR2 and BR3, which is then taken. In another lookup, the alternate path prediction is extended by performing another lookup to generate predictions for BR2.1 and BR3.1, which are both identified in a multi-taken entry. Accordingly, in the same entry, the alternate path prediction is even further extended with the prediction that BR2.1.1 and BR3.1.1 are also taken.

As above, the alternate path prediction is stored in the alternate prediction cache 46 with various tagging information. In this example, an entry of the alternate prediction cache 46 may indicate: [PB1; BR1_offset; N; BR2(N); BR3(T); BR3.1(T); BR3.1.1(T)].

If a flush signal is received indicative of the main path prediction of BR1 being incorrect, the block skipping circuitry 48 may lookup the alternate prediction cache 46 as described above to identify the prediction resumption address and to identify the sequence of instructions to be fetched up to the point at which predictions resume. For example, the prediction resumption address may be identified as the target address of BR3.1.1, and the branch predictor 40 is controlled to begin generating predictions from that address.

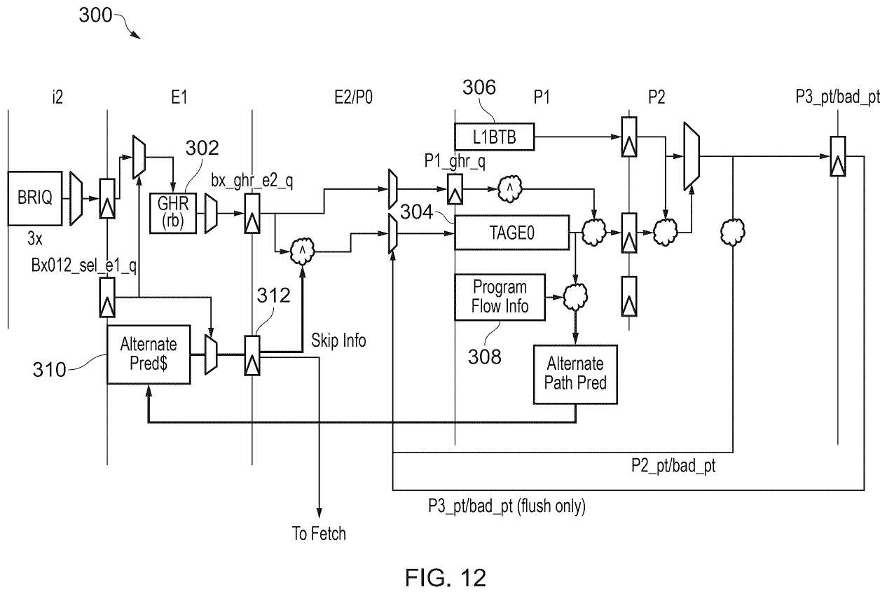

FIG. 12 illustrates an example embodiment incorporating the present techniques arranged in a prediction pipeline 300. The prediction pipeline 300 comprises a plurality of stages comprising control stages E1 and E2 and prediction stages P0, P1 and P2. The control stages and prediction stages may overlap, as shown in this example where E2 and P0 overlap. In this example, the prediction structure incorporates a TAGE predictor 304, but it will be appreciated that other prediction structures may be used instead. The TAGE predictor 304 is configured to return any generated predictions in the prediction stages, in particular at the end of stage P1.

The control stages comprise a global history register (GHR) 302, which is an example of the history tracking circuitry 125 described earlier, in which the history of program flow may be stored for indexing into the TAGE predictor 304. Hence, in the control stage E1, the GHR outputs the index for looking up the TAGE predictor 304 to generate a prediction in respect of an input branch instruction. The TAGE predictor 304 returns a predicted direction for the main path prediction in stage P1, which is then combined in stage P2 with a predicted target address retrieved from the BTB 306.

The TAGE 304 further generates at least one alternate path prediction in accordance with the present techniques. Program flow information 308 (e.g. the path information represented by the flow tracking circuitry 52 described earlier as shown in FIGS. 7A, 7B, 8A and 8B) is compared to identify whether the alternate path prediction corresponds with an observed path from the input branch instruction. If so, then the alternate path prediction is output to be stored in the alternate prediction cache 310. The alternate prediction cache 310 in this example is configured to return the alternate path prediction at the control stage E1, which appears earlier in the prediction pipeline 300 than the prediction stage P1 at which the main and alternate path predictions would be available based on looking up the TAGE 304.

In response to a flush signal indicative of the main path prediction being incorrect, the block skipping circuitry 312 generates skip information identifying a prediction resumption address, based on the alternate prediction cache. That prediction resumption address is then input to the control stage prior to the prediction stages, such that the TAGE 304 is then controlled to start generating predictions in respect of a block of instructions identified by the prediction resumption address. The skip information is further sent to a fetch stage 6, which is then enabled to sequentially fetch instructions according to the alternate path of program flow until the prediction resumption address, at which point new main path predictions are expected to be available.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

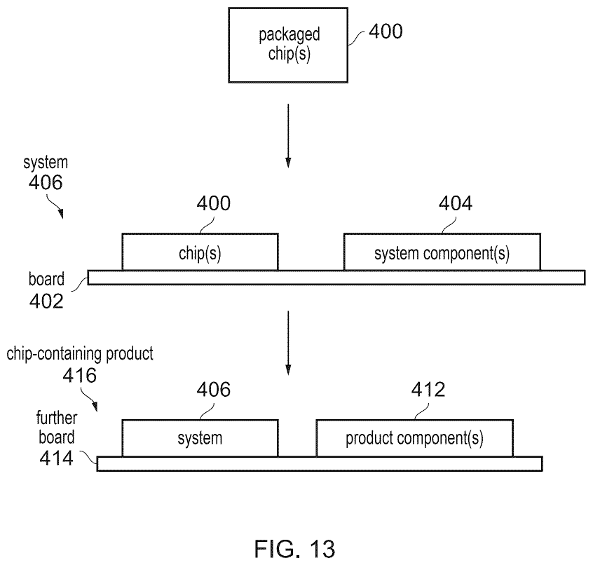

As shown in FIG. 13, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
(1) An apparatus comprising:
   branch prediction circuitry configured to generate predictions in respect of a given block of one or more instructions, the predictions comprising at least:
      a main path prediction in respect of a given branch instruction; and
      at least one alternate path prediction in respect of an alternate path of program flow predicted to be followed if the main path prediction is incorrect,
   wherein the branch prediction circuitry is configured to store the at least one alternate path prediction in an alternate prediction cache; and
   block skipping circuitry responsive to a flush signal indicative of the main path prediction being incorrect to control the branch prediction circuitry to begin generating predictions in respect of a subsequent block of instructions identified by a prediction resumption address;
   wherein the block skipping circuitry is configured to identify the prediction resumption address of the subsequent block of instructions based on the at least one alternate path prediction; and
   the block skipping circuitry is configured to support an encoding of the at least one alternate path prediction that indicates that the alternate path of program flow includes at least one taken branch.
(2) The apparatus of clause (1), wherein
   the branch prediction circuitry is configured to return the main path prediction and the at least one alternate path prediction at a prediction stage of a prediction pipeline;
   the alternate prediction cache is configured to return the at least one alternate path prediction at a control stage earlier in the prediction pipeline than the prediction stage.
(3) The apparatus of clause (1) or clause (2), wherein the branch prediction circuitry is configured to generate the main path prediction and at least one alternate path prediction from a single lookup in prediction data.
(4) The apparatus of any of clauses (1) to (3), wherein
   the branch prediction circuitry comprises:
      history tracking circuitry to maintain a program flow history based on predicted branch instructions satisfying a program flow history update condition, and
      at least one set-associative storage structure configured to store prediction data, in which the at least one set-associative storage structure comprises sets indexed by a portion of the program flow history that is independent of information relating to a most recently predicted branch instruction satisfying the program flow history update condition.
(5) The apparatus of clause (4), wherein:
   each set comprises two or more prediction entries each stored in association with a respective tag value to be compared with a tag, the tag being dependent on an indication of the given block and on a portion of the program flow history that is dependent on the information relating to the most recently predicted branch instruction satisfying the program flow history update condition; and
   the branch prediction circuitry is configured to generate the predictions in dependence on the one or more prediction entries.
(6) The apparatus of clause (5), wherein the indication of the given block is dependent on a program counter value.
(7) The apparatus of clause (5) or clause (6), wherein
   the at least one storage structure comprises a plurality of set-associative storage structures, wherein
   the plurality of set-associative storage structures comprise at least a long-history storage structure associated with a long history length and a short-history storage structure associated with a short history length; and
   in response to a given program flow history, the branch prediction circuitry is configured to identify the one or more prediction entries associated with the given program flow history in the long-history storage structure or the short-history storage structure.
(8) The apparatus of clause (7), wherein the branch prediction circuitry is configured to prioritise a hit in the long-history storage structure over a hit in the short-history storage structure for identifying a prediction entry to be used for the main prediction.
(9) The apparatus of any preceding clause, comprising:
   flow tracking circuitry configured to maintain program flow information indicative of one or more observed paths after a candidate branch instruction; and
   in a case where the given branch instruction corresponds to the candidate branch instruction, the branch prediction circuitry is configured to store the at least one alternate path prediction in the alternate prediction cache in response to the alternate path of program flow corresponding to one of the one or more observed paths.
(10) The apparatus of clause (9), wherein the one or more observed paths comprise information identifying at least one subsequent branch instruction encountered after the candidate branch instruction.
(11) The apparatus of clause (9) or clause (10), wherein
   the flow tracking circuitry is configured to enforce a maximum limit for a number of subsequent conditional branch instructions in each of the one or more observed paths, wherein
   the flow tracking circuitry is configured to support at least one observed path comprising a number of conditional branch instructions corresponding to the maximum limit followed by at least one unconditional branch instruction.
(12) The apparatus of any of clauses (9) to (11), wherein the flow tracking circuitry is configured to select the candidate branch instruction in response to a determination that the candidate branch instruction has a misprediction rate exceeding a threshold.
(13) The apparatus of clause (12), comprising a branch target buffer configured to store one or more values indicative of the misprediction rate for one or more branch instructions.
(14) The apparatus of any preceding clause, wherein the alternate prediction cache is configured to store the at least one alternate path prediction in association with an identifier of the given block of instructions.
(15) The apparatus of any preceding clause, wherein the alternate prediction cache is configured to store the at least one alternate path prediction in association with an offset of the given branch instruction.
(16) The apparatus of any preceding clause, wherein in response to the at least one taken branch being a return instruction, the branch prediction circuitry is configured to generate the at least one alternate path prediction to comprise a pointer to a call-return stack.
(17) The apparatus of any preceding clause, wherein
   in a case where the given branch instruction is a polymorphic branch instruction, the main path prediction comprises a first target address of the given branch instruction, and the at least one alternate path prediction comprises a second target address of the given branch instruction, and
   the alternate prediction cache is configured to store the at least one alternate path prediction in association with the second target address.
(18) A system comprising:
   the apparatus of any preceding clause, implemented in at least one packaged chip;
   at least one system component; and
   a board,
   wherein the at least one packaged chip and the at least one system component are assembled on the board.
(19) A chip-containing product comprising the system of clause (18), wherein the system is assembled on a further board with at least one other product component.
(20) A method comprising:
   generating predictions in respect of a given block of one or more instructions, the predictions comprising at least:
      a main path prediction in respect of a given branch instruction; and
      at least one alternate path prediction in respect of an alternate path of program flow predicted to be followed if the main path prediction is incorrect,
   storing the at least one alternate path prediction in an alternate prediction cache; and
   in response to a flush signal indicative of the main path prediction being incorrect to control the branch prediction circuitry to begin generating predictions in respect of a subsequent block of instructions identified by a prediction resumption address;
   identifying the prediction resumption address of the subsequent block of instructions based on the at least one alternate path prediction; and
   supporting an encoding of the at least one alternate path prediction that indicates that the alternate path of program flow includes at least one taken branch.
(21) A non-transitory computer-readable medium storing computer-readable code for fabrication of an apparatus comprising:
   branch prediction circuitry configured to generate predictions in respect of a given block of one or more instructions, the predictions comprising at least:
      a main path prediction in respect of a given branch instruction; and
      at least one alternate path prediction in respect of an alternate path of program flow predicted to be followed if the main path prediction is incorrect,
   wherein the branch prediction circuitry is configured to store the at least one alternate path prediction in an alternate prediction cache; and
   block skipping circuitry responsive to a flush signal indicative of the main path prediction being incorrect to control the branch prediction circuitry to begin generating predictions in respect of a subsequent block of instructions identified by a prediction resumption address;
   wherein the block skipping circuitry is configured to identify the prediction resumption address of the subsequent block of instructions based on the at least one alternate path prediction; and
   the block skipping circuitry is configured to support an encoding of the at least one alternate path prediction that indicates that the alternate path of program flow includes at least one taken branch.
(22) An apparatus comprising:
   prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
   prediction resumption circuitry configured to identify, based on stored information dependent on the multi-taken entry, a prediction resumption address in response to a flush signal, the prediction resumption address being an address in respect of which at least one prediction is to be generated after the flush signal.
(23) The apparatus of clause (22), comprising prediction circuitry configured to perform a lookup in the prediction storage circuitry to generate a prediction in respect of a given branch instruction; and
   the prediction circuitry is configured to generate and store the stored information in a prediction resumption cache in response to generating a prediction in respect of a given branch instruction.
(24) The apparatus of clause (23), wherein the flush signal is indicative of the prediction being incorrect.
(25) The apparatus of clause (23) or clause (24), wherein the given branch instruction is different to the respective branch instruction associated with the multi-taken entry.
(26) The apparatus of any of clauses (23) to (25), wherein the prediction circuitry is configured to generate the prediction and the stored information in a single lookup in the prediction storage circuitry.
(27) The apparatus of any preceding clause, comprising:
   history tracking circuitry configured to maintain a program flow history based on predicted branch instructions satisfying a program flow history update condition;
   wherein the prediction storage circuitry comprises at least one set-associative storage structure, in which the at least one set-associative storage structure comprises sets indexed by a portion of the program flow history that is independent of information relating to a most recently predicted branch instruction satisfying the program flow history update condition.
(28) The apparatus of clause (27), wherein each set comprises two or more prediction entries each stored in association with a respective tag value to be compared with a tag, the tag being dependent on an indication of a branch instruction and on a portion of the program flow history that is dependent on the information relating to the most recently predicted branch instruction satisfying the program flow history update condition.
(29) The apparatus of clause (27), wherein the two or more prediction entries support the encoding of the multi-taken entry.
(30) The apparatus of any of clauses (27) to (29), wherein the indication of the branch instruction is dependent on a program counter value.
(31) The apparatus of any of clauses (27) to (30), wherein
   the at least one storage structure comprises a plurality of set-associative storage structures, wherein
   the plurality of set-associative storage structures comprise at least a long-history storage structure associated with a long history length and a short-history storage structure associated with a short history length; and
   in response to a given program flow history, the branch prediction circuitry is configured to identify the one or more prediction entries associated with the given program flow history in the long-history storage structure or the short-history storage structure.
(32) The apparatus of any preceding clause, comprising:
   flow tracking circuitry configured to maintain program flow information indicative of one or more observed paths after a candidate branch instruction; and
   wherein in a case where a prediction is to be generated in respect of the candidate branch instruction, the flow tracking circuitry is configured to cause the stored information to be stored in response to the multi-taken entry indicating a program flow corresponding to one of the one or more observed paths.
(33) The apparatus of clause (32), wherein the one or more observed paths comprise information identifying at least one subsequent branch instruction encountered after the candidate branch instruction.
(34) The apparatus of clause (32) or clause (33), wherein
   the flow tracking circuitry is configured to enforce a maximum limit for a number of subsequent conditional branch instructions in each of the one or more observed paths, wherein
   the flow tracking circuitry is configured to support at least one observed path comprising a number of conditional branch instructions corresponding to the maximum limit followed by at least one unconditional branch instruction.
(35) The apparatus of any of clauses (32) to (34), wherein the flow tracking circuitry is configured to select the candidate branch instruction in response to a determination that the candidate branch instruction has a misprediction rate exceeding a threshold.
(36) The apparatus of any of clauses (22) to (35), wherein the prediction storage circuitry is configured to store a multi-taken entry specifying an unconditional branch instruction as one of the at least one subsequent branch instruction.
(37) The apparatus of any of clauses (22) to (36), wherein the prediction storage circuitry is configured to store a multi-taken entry specifying, as one of the at least one subsequent branch instruction, a conditional branch instruction which is predicted to be taken and has an associated confidence value exceeds a threshold.
(38) A system comprising:
   the apparatus of any of clauses (22 to (37), implemented in at least one packaged chip;
   at least one system component; and
   a board,
   wherein the at least one packaged chip and the at least one system component are assembled on the board.
(39) A chip-containing product comprising the system of clause (38), wherein the system is assembled on a further board with at least one other product component.
(40) A method comprising:
   storing a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
   identifying, based on stored information dependent on the multi-taken entry, a prediction resumption address in response to a flush signal, the prediction resumption address being an address in respect of which at least one prediction is to be generated after the flush signal.
(41) A non-transitory computer-readable medium storing computer-readable code for fabrication of an apparatus comprising:
   prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
   prediction resumption circuitry configured to identify, based on stored information dependent on the multi-taken entry, a prediction resumption address in response to a flush signal, the prediction resumption address being an address in respect of which at least one prediction is to be generated after the flush signal.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
prediction resumption circuitry configured to identify, based on stored information dependent on the multi-taken entry, a prediction resumption address in response to a flush signal, the prediction resumption address being an address in respect of which at least one prediction is to be generated after the flush signal.

2. The apparatus of claim 1, comprising prediction circuitry configured to perform a lookup in the prediction storage circuitry to generate a prediction in respect of a given branch instruction; and
the prediction circuitry is configured to generate and store the stored information in a prediction resumption cache in response to generating a prediction in respect of a given branch instruction.

3. The apparatus of claim 2, wherein the flush signal is indicative of the prediction being incorrect.

4. The apparatus of claim 2, wherein the given branch instruction is different to the respective branch instruction associated with the multi-taken entry.

5. The apparatus of claim 2, wherein the prediction circuitry is configured to generate the prediction and the stored information in a single lookup in the prediction storage circuitry.

6. The apparatus of claim 1, comprising:
history tracking circuitry configured to maintain a program flow history based on predicted branch instructions satisfying a program flow history update condition;
wherein the prediction storage circuitry comprises at least one set-associative storage structure, in which the at least one set-associative storage structure comprises sets indexed by a portion of the program flow history that is independent of information relating to a most recently predicted branch instruction satisfying the program flow history update condition.

7. The apparatus of claim 6, wherein each set comprises two or more prediction entries each stored in association with a respective tag value to be compared with a tag, the tag being dependent on an indication of a branch instruction and on a portion of the program flow history that is dependent on the information relating to the most recently predicted branch instruction satisfying the program flow history update condition.

8. The apparatus of claim 7, wherein the two or more prediction entries support the encoding of the multi-taken entry.

9. The apparatus of claim 7, wherein the indication of the branch instruction is dependent on a program counter value.

10. The apparatus of claim 6, wherein
the at least one storage structure comprises a plurality of set-associative storage structures, wherein
the plurality of set-associative storage structures comprise at least a long-history storage structure associated with a long history length and a short-history storage structure associated with a short history length; and
in response to a given program flow history, the branch prediction circuitry is configured to identify the one or more prediction entries associated with the given program flow history in the long-history storage structure or the short-history storage structure.

11. The apparatus of claim 1, comprising:
flow tracking circuitry configured to maintain program flow information indicative of one or more observed paths after a candidate branch instruction; and
wherein in a case where a prediction is to be generated in respect of the candidate branch instruction, the flow tracking circuitry is configured to cause the stored information to be stored in response to the multi-taken entry indicating a program flow corresponding to one of the one or more observed paths.

12. The apparatus of claim 11, wherein the one or more observed paths comprise information identifying at least one subsequent branch instruction encountered after the candidate branch instruction.

13. The apparatus of claim 11, wherein
the flow tracking circuitry is configured to enforce a maximum limit for a number of subsequent conditional branch instructions in each of the one or more observed paths, wherein
the flow tracking circuitry is configured to support at least one observed path comprising a number of conditional branch instructions corresponding to the maximum limit followed by at least one unconditional branch instruction.

14. The apparatus of claim 11, wherein the flow tracking circuitry is configured to select the candidate branch instruction in response to a determination that the candidate branch instruction has a misprediction rate exceeding a threshold.

15. The apparatus of claim 1, wherein the prediction storage circuitry is configured to store a multi-taken entry specifying an unconditional branch instruction as one of the at least one subsequent branch instruction.

16. The apparatus of claim 1, wherein the prediction storage circuitry is configured to store a multi-taken entry specifying, as one of the at least one subsequent branch instruction, a conditional branch instruction which is predicted to be taken and has an associated confidence value exceeds a threshold.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
identifying, based on stored information dependent on the multi-taken entry, a prediction resumption address in response to a flush signal, the prediction resumption address being an address in respect of which at least one prediction is to be generated after the flush signal.

20. A non-transitory computer-readable medium storing computer-readable code for fabrication of an apparatus comprising:
prediction storage circuitry configured to store a plurality of prediction entries, each prediction entry indicative of whether a respective branch instruction is predicted to be taken or not taken, wherein at least one prediction entry supports an encoding of a multi-taken entry indicating that the respective branch instruction and at least one subsequent branch instruction are each predicted to be taken; and
prediction resumption circuitry configured to identify, based on stored information dependent on the multi-taken entry, a prediction resumption address in response to a flush signal, the prediction resumption address being an address in respect of which at least one prediction is to be generated after the flush signal.
